(19) United States
(12) Patent Application Publication
(10) Pub. No.: US 2024/0351850 A1
(43) Pub. Date: Oct. 24, 2024

(54) SYSTEM AND METHOD FOR CONTACTLESS DRINK DISPENSING

(71) Applicant: Backbar Solutions, Escondido, CA (US)

(72) Inventors: Rishabh KEWALRAMANI, San Diego, CA (US); Kevin P. Monpara, San Diego, CA (US); Adam Elghor, San Diego, CA (US); Brian Jeremy Kaplan, San Diego, CA (US); Samuel Viseur, San Diego, CA (US)

(21) Appl. No.: 18/575,007

(22) PCT Filed: Jun. 27, 2022
(86) PCT No.: PCT/US22/35117

§ 371 Date: Dec. 28, 2023

Related U.S. Application Data
(60) Provisional application No. 63/215,772, filed on Jun. 28, 2021.

(51) Int. Cl. B67D 1/00; B67D 1/08; B67D 1/10

(52) U.S. Cl. CPC B67D 1/0041; B67D 1/0888; B67D 1/0894; B67D 1/108; B67D 1/0034

(57) ABSTRACT

The present disclosure relates to automatic drink preparation. The apparatus can be communicatively coupled to ordering tablets and user interfaces for requesting cocktails. The apparatus can include a nozzle with a first pipe having a first diameter, a second pipe having a second diameter, and a third pipe having a third diameter. Each pipe can be fluidly coupled to a tube. Each tube can be fluidly coupled to a peristaltic pump that can pump fluids such as soda, alcohol, or syrup. The apparatus can include a first conveyor and a second conveyor to convey containers to the nozzle. The nozzle can move along a gantry to position above either of the conveyors, and the pumps can pump fluids through the tubes to the pipes in the nozzle for release into the containers.

### FIELD OF THE DISCLOSURE

The present application generally relates to apparatus for making drinks.

### BACKGROUND OF THE DISCLOSURE

Cocktails and mixed drinks are high profit-margin items for bars, restaurants, and other establishments where drinks are sold. Yet these establishments frequently limit such offerings, as the creation of cocktails and mixed drinks requires substantially more time and effort than pouring wine or draft beverages. The complexity and time required increases as a cocktail and mixed drink menu size increases. The bartender must fetch each drink and clean measurement apparatuses and other barware between preparations of different drinks to prevent cross-contamination of drinks. Further, when cocktails are offered, bartenders may dislike making them, as it is difficult to converse with patrons while focusing on pouring precise amounts of various ingredients.

### BRIEF SUMMARY OF THE DISCLOSURE

The present disclosure relates to automatic drink preparation. The apparatus can be communicatively coupled to ordering tablets and user interfaces for requesting cocktails. The apparatus can include a nozzle with a first pipe having a first diameter, a second pipe having a second diameter, and a third pipe having a third diameter. Each pipe can be fluidly coupled to a tube. Each tube can be fluidly coupled to a peristaltic pump that can pump fluids such as soda, alcohol, or syrup. The apparatus can include a first conveyor and a second conveyor to convey containers to the nozzle. The nozzle can move along a gantry to position above either of the conveyors, and the pumps can pump fluids through the tubes to the pipes in the nozzle for release into the containers.

In some embodiments, the apparatus includes a gantry. The nozzle is mounted to the gantry, the gantry having a first dispensing position and a second dispensing position. In certain embodiments, the apparatus includes a first conveyor to position a first container under the first nozzle dispensing position and a second conveyor to position a second container under the second nozzle dispensing position. In certain embodiments, the first conveyor can include a proximal portion, a distal portion, and a middle portion under the first nozzle dispensing position and between the proximal portion and the distal portion. In certain embodiments, the apparatus includes an ice auger receiving ice from an ice reservoir and providing the ice to the ice dispensing mechanism. In some embodiments, the apparatus includes an ice dispensing mechanism controlled by the processor. In certain embodiments, the ice dispensing mechanism further comprises an ice measurement chamber, and a motor that rotates the ice measurement chamber to dispense the ice. In some embodiments, the nozzle further defines a third plurality of pipes, each pipe having a third diameter. In certain embodiments, the third plurality of pipes accepts post mix syrup. In some embodiments, the first plurality of pipes carrying a liquid having an alcohol content greater than 10% alcohol by volume. In some embodiments, the apparatus includes a display screen. The display screen provides a graphical user interface for operation of the automatic drink preparation apparatus. In some embodiments, the apparatus includes a network interface receiving commands to operate the automatic drink preparation apparatus. In some embodiments, the apparatus includes an integration module configured to operate the automatic drink preparation apparatus according to orders from a point-of-sale system.

In another aspect, the present disclosure relates to a method for automatically preparing drinks. The method includes a first conveyor conveying a first container to an ice-dispensing area below an ice reservoir and a second conveyor conveying a second container to the ice-dispensing area below the ice reservoir. The method further includes the first conveyor conveying the first container to a dispensing area beneath a nozzle and conveying the second container to the dispensing area. The method also includes pumping a first liquid through the nozzle into the first container, positioning the nozzle over the second container, and pumping a second liquid through the nozzle into the second container. Additionally, the method includes the first conveyor conveying the first container to a pickup area, and the second conveyor conveying the second container to the pickup area.

In some embodiments, the method includes receiving a drink order transmitted via a network and identifying a first drink and second drink. In certain embodiments, the method includes a processor verifying the availability of a first liquid and a second liquid for a first drink. In some embodiments, the method includes an ice measurement chamber determining a number of ice units for the first drink. In some embodiments, the method includes the ice dispenser dispensing, until the determined number of ice units have been dispensed, ice moved by an ice auger into the ice measurement chamber. In some embodiments, the method includes the ice dispenser dispensing, until the determined number of ice units have been dispensed, the ice from ice measurement chamber into the first container. In some embodiments, the method includes the processor transmitting a notification that the first drink and the second drink are ready. In some embodiments, the method includes lasers indicating a first position for the first container on the first conveyor and a second position for the second container on the second conveyor. In some embodiments, the method includes the sensors verifying the first container was placed at a first position on the first conveyor and the second container was placed at a second position on the second conveyor. In some embodiments, a gantry moves the nozzle into position to release the liquids into the containers.

In another aspect, the present disclosure relates to a method for automatically preparing drinks. The method can include transmitting a first instruction to a first conveyor motor to convey a first container disposed on a first conveyor to an ice-dispensing area below an ice reservoir. The method can include transmitting, by the one or more processors, a second instruction to a second conveyor motor to convey a second container disposed on a second conveyor to the ice-dispensing area below the ice reservoir. The method can include transmitting, by the one or more processors, a third instruction to the first conveyor motor to convey the first container to a fluid-dispensing area beneath a nozzle. The method can include transmitting, by the one or more processors, a fourth instruction to the second conveyor motor to convey the second container to the fluid-dispensing area. The method can include transmitting, by the one or more processors, a fifth instruction to a first peristaltic pump to pump a first set of fluids through the nozzle into the first container. The method can include transmitting, by the one or more processors, a sixth instruction to a gantry to position the nozzle over the second container. The method can include transmitting, by the one or more processors, a seventh instruction to a second peristaltic pump to pump a second set of fluids through the nozzle into the second container. The method can include transmitting, by the one or more processors, an eighth instruction to the first conveyor and the second conveyor to convey the first container and the second container to a pickup area.

The details of various embodiments are set forth in the accompanying drawings and the description below.

### BRIEF DESCRIPTION OF THE FIGURES

The accompanying drawings are not intended to be drawn to scale. Like reference numbers and designations in the various drawings indicate like elements. For purposes of clarity, not every component can be labeled in every drawing. In the drawings:

FIG. 1A is a diagram illustrating an embodiment of a drink preparation apparatus, according to some embodiments;

FIG. 1B is a cross-sectional view of the drink preparation apparatus of FIG. 1A;

FIG. 2A is a an embodiment of the ice dispenser;

FIG. 2B is a cutaway view of one embodiment of the ice dispenser which includes the ice measurement chamber and the motor;

FIG. 3 is a perspective view illustration of an ice reservoir with an ice auger, according to some embodiments;

FIG. 4A is a cutaway view of one embodiment of the gantry and the nozzle;

FIG. 4B is a perspective view illustration of the nozzle mounted to a gantry mechanism in a first dispensing position, according to some embodiments;

FIG. 4C is a perspective view illustration of the nozzle mounted to the gantry mechanism in a second dispensing position, according to some embodiments;

FIG. 5A is a top view illustration of a nozzle with variously sized tubes, according to some embodiments;

FIG. 5B is a top cross sectional view illustration of the nozzle without a top cap, according to some embodiments;

FIG. 5C is a side cross sectional view illustration of the nozzle without a bottom cap, according to some embodiments;

FIG. 5D is a bottom view illustration of the nozzle, according to some embodiments;

FIG. 5E is a bottom view illustration of the nozzle, according to some embodiments;

FIG. 6 is a system diagram illustrating an embodiment of the drink preparation apparatus, according to some embodiments;

FIG. 7 is a block diagram illustrating an embodiment for dispensing liquids from the nozzle;

FIG. 8 is a block diagram illustrating an embodiment for dispensing liquids from the nozzle;

FIG. 9 is a block diagram illustrating an embodiment of an web infrastructure communicating with a drink preparation apparatus in a networking environment

FIG. 10 is a block diagram illustrating an embodiment of a drink preparation environment;

FIG. 11A is a flow diagram of an embodiment of a method for preparing drinks;

FIG. 11B is a flow diagram of an embodiment of the method of FIG. 11A for preparing drinks;

FIG. 12 is a flow diagram of an embodiment of a method for ordering drinks;

FIGS. 13A-13C are flow diagrams of an embodiment of a method for ordering drinks;

FIG. 14 is a flow diagram of an embodiment of a method for changing liquids;

FIG. 15 is a flow diagram of an embodiment of a method for clock synchronization;

FIG. 16 is a flow diagram of an embodiment of a method for status updates;

FIG. 17 is a flow diagram of an embodiment of a method for a log dump;

FIG. 18 is a flow diagram of an embodiment of a method calibrating the drink preparation apparatus;

The features and advantages of the present solution will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

Below are detailed descriptions of various concepts related to, and embodiments of, techniques, approaches, methods, apparatuses, and systems for adjusting an aspect ratio of a content slot. The various concepts introduced above and discussed in detail below can be implemented in any of numerous ways, as the described concepts are not limited to any particular manner of embodiment. Examples of specific embodiments and applications are provided primarily for illustrative purposes.

The present disclosure relates to automatic drink preparation. The apparatus can be communicatively coupled to ordering tablets and user interfaces for requesting cocktails. The apparatus can include a nozzle with a first pipe having a first diameter, a second pipe having a second diameter, and a third pipe having a third diameter. Each pipe can be fluidly coupled to a tube. Each tube can be fluidly coupled to a peristaltic pump that can pump fluids such as soda, alcohol, or syrup. The apparatus can include a first conveyor and a second conveyor to convey containers to the nozzle. The nozzle can move along a gantry to position above either of the conveyors, and the pumps can pump fluids through the tubes to the pipes in the nozzle for release into the containers.

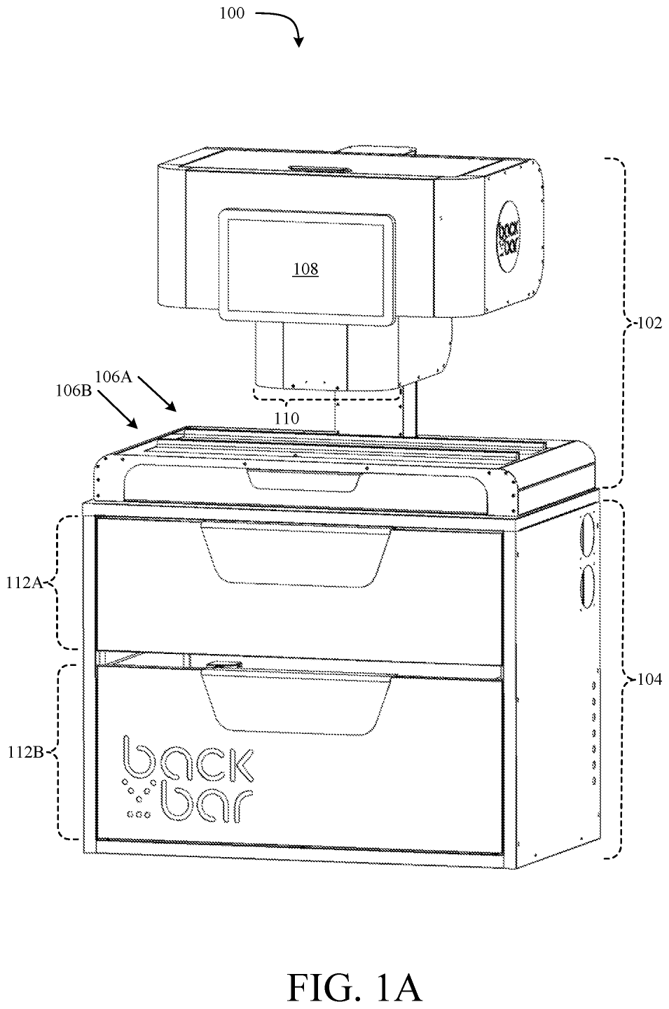

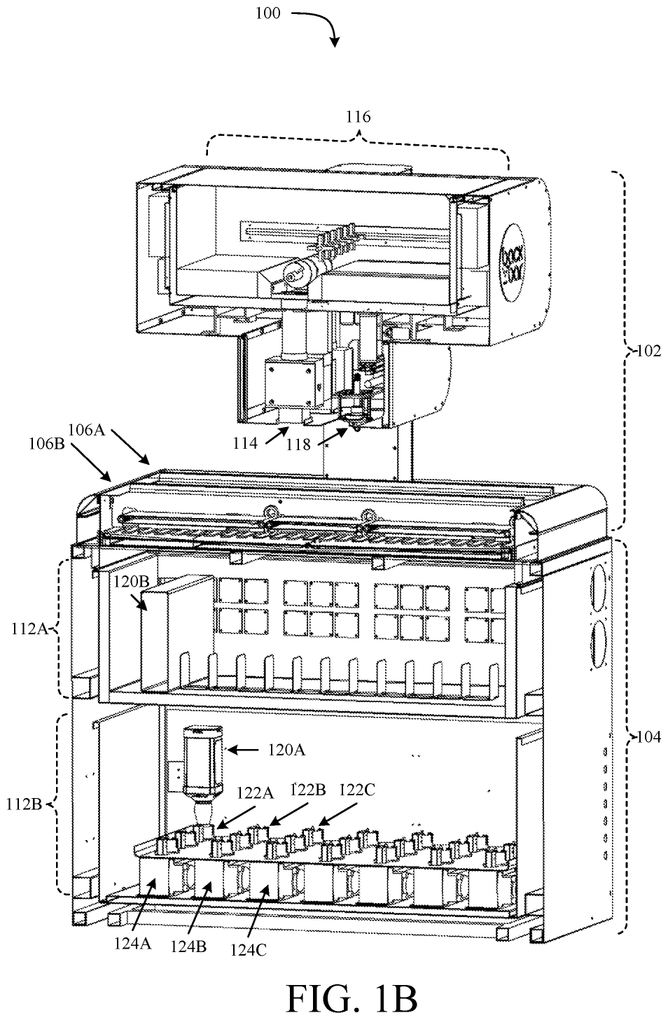

Referring now to FIG. 1A, and in brief overview, an embodiment of a drink preparation apparatus 100 is shown. The drink preparation apparatus 100 includes a dispensing unit 102 and an ingredient cabinet 104. The dispensing unit 102 includes conveyors 106A and 106B (generally referred to as conveyors 106), a screen 108, and a dispensing area 110. The tray assembly 104 can include drawers 112A-B (generally referred to as drawers 112).

Still referring to FIG. 1A and in further detail, the dispensing unit 102 can be the dispensing and conveying unit of the automatic drink preparation apparatus 100. The dispensing unit 102 can be made of metal, wood, or plastic. The dispensing unit 102 can include a logo or labels. For example, in some embodiments, the dispensing unit 102 may be branded with one or more logos for product to be dispensed by the drink preparation apparatus 100. In other embodiments, the dispensing unit 102 branding may be unrelated to dispensed product, such as branding for the establishment in which the drink preparation apparatus 100 is deployed. In still other embodiments, the dispensing unit 102 branding may be wholly unrelated to dispensed product, such as branding for a sports team or business organization.

The conveyors 106 can transport containers, such as glasses and cups. One or more conveyors 106 can individually or synchronously convey containers to the dispensing area 110 to receive drinks. For example, conveyor 106A can convey containers while the conveyor 106B does not move. Although only two conveyors 106A and 106B are shown in FIG. 1B, any number of conveyors 106 may be provided to increase the number of drinks that can be made concurrently. Drinks are dispensed in the dispensing area 110 and into the containers on the conveyor 106. The dispensing area 110 can provide ice, liquids, or other liquids into the containers. The dispensing area 110 can dispense liquids stored in the ingredient cabinet 104. The conveyors 106 can receive the containers from a user, such as bar back, bartender, or any other food preparation worker. The conveyors 106 can also receive containers from an automated system, such as a robot or containers dispenser. The conveyors 106 can include belts or any other surface configured to receive and transport a containers. For example, the conveyors 106 can include a non-slip surface that is made of rubber. The conveyors 106 can include additional materials such as a top cover, a carcass, and a bottom cover. The top cover can be configured to receive the containers. The carcass can provide linear strength and shape of the conveyor. The carcass can include woven or metal fabric that includes longitudinal cords with particular elasticity and resistance to define a structure of the conveyors 106. The carcass can include steel, polyester, nylon, cotton, aramid, synthetic fibers, or a combination thereof. The bottom cover of the conveyors 106 can include rubber or plastic compounds that are configured to couple to motors driving the conveyors 106.

The conveyor 106 can be driven by a stepper motor, an inchworm motor, or any other piezoelectric motor, DC motor, or AC motor. The motors can move or rotate the conveyor 106 to convey the containers on the conveyor 106. The motors can rotate a pulley to move the conveyor 106. The motor can receive voltage and convert it to rotations of the shaft coupled to the pulley to move the conveyor 106. The motor can include electromagnets that divide the rotations of the motor into steps. The motor then generates current to energize the electromagnet corresponding to each step to rotate a shaft of the motor through the steps to rotate the pulley to move the conveyor 106. In some embodiments, the motor can also keep a particular electromagnet energized to maintain the shaft in the corresponding position and thus maintain the position of the conveyor 106. For example, the motor can maintain the position of the conveyor 106 when the container is under the ice dispenser 114 or the nozzle 118 to receive ice or liquids from the receptacles 120, respectively.

The screen 108 can include a touch screen for managing or controlling the operation of the automatic drink preparation apparatus 100. In some embodiments, the display screen 108 can provides prompts to an operator concerning operation and status of the drink preparation apparatus 100, such as the status of consumables necessary to make drinks or that a drink order is ready to be served. The screen 108 can also display orders for drinks from a user. The screen 108 can display a graphical user interface (GUI) to display information about the orders for the drinks. The information can indicate a selection of a pre-set drink, such as a martini or a combination of whiskey and soda. The screen 108 can display custom information about the order. The screen 108 can also receive commands for operating the drink preparation apparatus 100. For example, the display 108 can be a touchscreen and the GUI can display options relating to operation of the drink preparation apparatus 100. The display screen 108 could receive selections in the GUI to operate the drink preparation apparatus 100. The selections can be related to which drink to make, how much of the drink to make (e.g., 50 mL, 100 mL, 150 mL, etc.) and how much ice to add. Additional details can specify which pumps to actuate and a speed at which to release liquids from various pipes, and a size of the ice crushed by the ice auger.

The screen 108 can also display information about the containers on the conveyor 106. For example, the screen 108 can display a size of the container and which containers on which conveyor 106 will receive the drink. The screen 108 can be communicatively coupled to a processor for managing the automatic drink preparation apparatus 100. The screen 108 can be communicatively coupled to hardware for connecting to other computers, networks, ordering software, or tablets. The hardware can support wireless connections via near-field communication (NFC), Bluetooth, Wi-Fi, or any kind of cellular connection (e.g., 5G, 4G, 3G, etc.).

Now referring to FIGS. 1B and 1n brief overview, shown is a cross-sectional view of an embodiment of the automatic drink preparation apparatus 100. As shown in FIG. 1B, the dispensing unit 102 can include an ice dispenser 114, an ice reservoir 116, and a nozzle 118. The drawers 112A and 112B can include receptacles 120A and 120B (generally referred to as receptacles 120), connectors 122A-C (generally referred to as connectors 122), and pumps 124A-124C (generally referred to as pump 124). The receptacles 120 can be plastic bottles, glass bottles, liquor bottles, bins, or jugs. Each of the receptacles 120 can include liquids for the drinks such as water, juice, seltzer, vodka, whiskey, syrup, or any other substance.

Still referring to FIG. 1B, and in further detail, the ingredient cabinet 104 can provide one or more drawers 112A and 112B providing storage for the receptacles 120. The ingredient cabinet 104 can be connected to the dispensing unit 102. Although only two drawers 112 are shown in the embodiment depicted in FIGS. 1A and 1B, any number of drawers 112 may be provided. In some embodiments, drawers 112 are provided in a side-by-side configuration rather than an “under over” configuration.

The drawers 112 can store the receptacles 120 with the liquids for the drinks. Each drawer 112 can store different liquids and in different conditions. For example, the drawer 112A can be a refrigerated top drawer for fresh juices and mixers. The bottom drawer 112B can be a drawer for liquor bottles. In some embodiments, the drawer 112A can provide a first temperature and humidity for storing receptacle 120B, and the drawer 112B can provide a second temperature and humidity for storing receptacle 120A.

The drawers can include connectors 122 for connecting the containers to the pumps 124. The connectors 122 can extend from the pumps 124. The connectors 122 can be ports, fasteners, barbs, or any other fitting that can connect with different receptacles 120. The connectors 122 can be metal, rubber, or plastic. For example, the connector 122A can be a barb such that the receptacle 120A can twist into the connector 122A. In another example, the connector 122D can be a push-pull mechanism such that the receptacle 120B is pushed into the connector 122D. As shown in FIG. 1B, drawer 112A provides twelve locations with corresponding connector 122 into which juice or house mix receptacles 120 may be installed, although any number of locations may be provided. Similarly, FIG. 1B depicts an embodiment in which seven banks of three connectors 122 for receptacles 120 such as liquor bottles to be accommodated although, again, any number of receptacles 120 may be accommodated.

The drawers can include the pumps 124 for pumping the liquids. The pumps 124 can also be peristaltic pumps. The pumps 124 can pump liquids into tubes connected to the nozzle 118. In some embodiments, each of the plurality of peristaltic pumps 124 is fluidly coupled with a respective one of a plurality of liquid tubes. Each tube can connect to each of the pipes 502. Accordingly, the pumps 124 can pump liquids from specific receptacles 120 through specific tubes to specific pipes 502 to dispense mixed drinks. The pumps 124 can pump liquids such as water, juice, seltzer, vodka, whiskey, syrup, or any other beverage. For example, the pumps 124 may be configured to pump liquids for human consumption. The pumps 124 can pump liquids at different rates. For example, the pumps 124 can pump at 5 mL/second, 50 mL/second, or 100 ml/second. The pumps 124 can be powered by an external power source. The external power source can modulate the rate of flow provided by the pumps. The pumps 124 also receive signals or instructions from the processor to pump at various flow rates. The pumps 124 can receive liquids to pump from the receptacles 120.

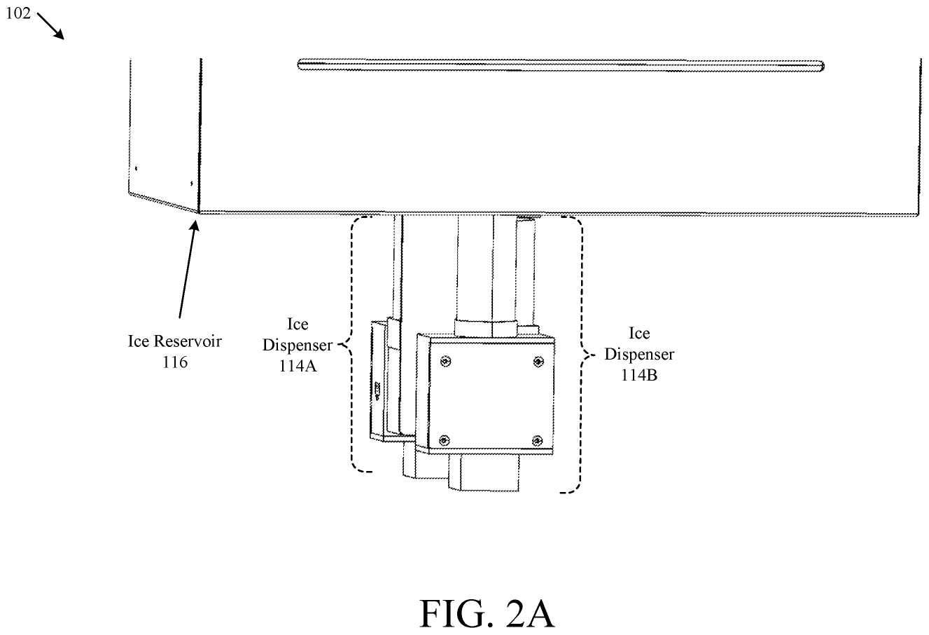

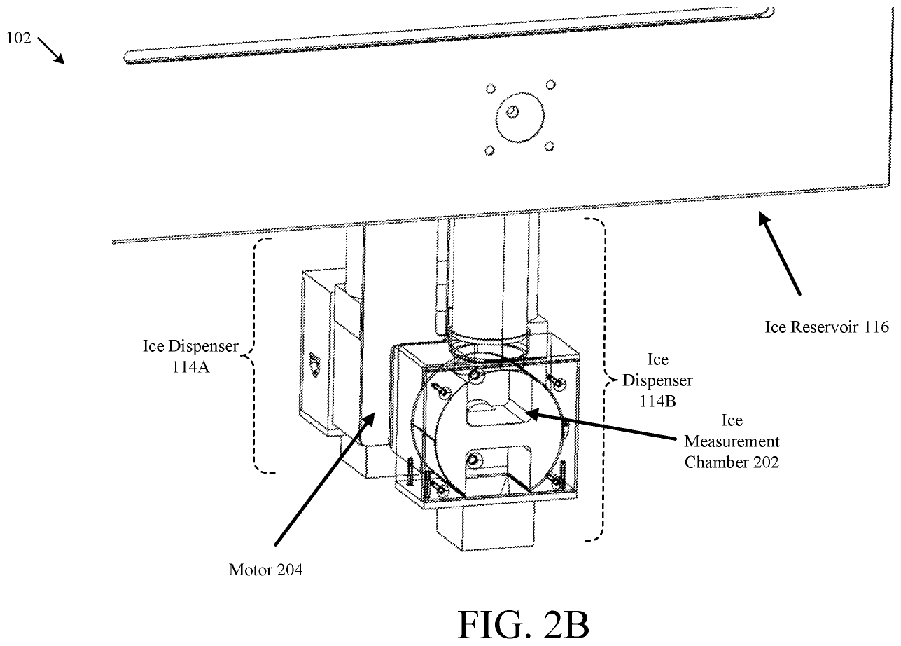

Now referring to FIG. 2A, depicted is one embodiment of ice dispenser 114. In one embodiment, the apparatus 100 provides an ice dispenser 114 associated with each conveyor 106 and dispenses ice into containers on the corresponding conveyor 106. For example, ice dispenser 114A can dispense ice into containers on conveyor 106A, and ice dispenser 114B can dispense ice into containers on conveyor 106B. The ice dispenser 114 can receive or retrieve ice from the ice reservoir 116 and release the ice. The ice dispenser 114 can also receive or retrieve ice from the ice reservoir 116, and dispense or release the ice. For example, the ice dispenser 114 can dispense ice cubes or crushed ice.

Now referring to FIG. 2B, and in brief overview, shown is a cutaway view of one embodiment of ice dispenser 114 which includes an ice measurement chamber 202 and a motor 204. The ice measurement chamber 202 can limit how much ice the ice dispenser 114 dispenses to that which will fit in the chamber 202. In some embodiments, the ice measurement chamber 202 includes sensors to measure ice by weight or volume. The ice measurement chamber 202 measures ice based on actuations of an ice auger or the motor 204. In some of these embodiments, a processor can receive the measurements from the sensors and transmit that data to the display screen 108.

The motor 204 can rotate the unit measurement chamber 202 to dispense the ice. The motor 204 can be an electric motor. A processor can control the motor 204. The motor 204 can dispense the ice by applying a force or rotations at/with a certain number of rotations per minute. The motor 204 can be a stepper motor, an inchworm motor, or any other piezoelectric motor, DC motor, or AC motor for precisely applying a force to dispense the ice. The motor 204 can include sensors to measure the force or rotations applied. The display screen 108 can display data from the sensors to display the activity of the motor.

Referring back to FIGS. 1B and 1n further detail, the ice reservoir 116 can be a container configured to store ice. The ice reservoir 116 can be a metal or plastic container that stores ice for human consumption. The ice reservoir 116 can include sensors for detecting how much ice is in the ice reservoir 116. For example, the ice reservoir 116 can include visual sensors, weight sensors, or laser sensors. The screen 108 can display the measurements from the aforementioned sensors to display how much ice is in the ice reservoir 116. For example, the screen 108 can display the sensor measurements indicating that the ice reservoir 116 is full of ice or is preparing more ice. In some embodiments, there may be an ice maker attached to the ice reservoir 116. The ice maker can be configured to make ice in the ice reservoir 116.

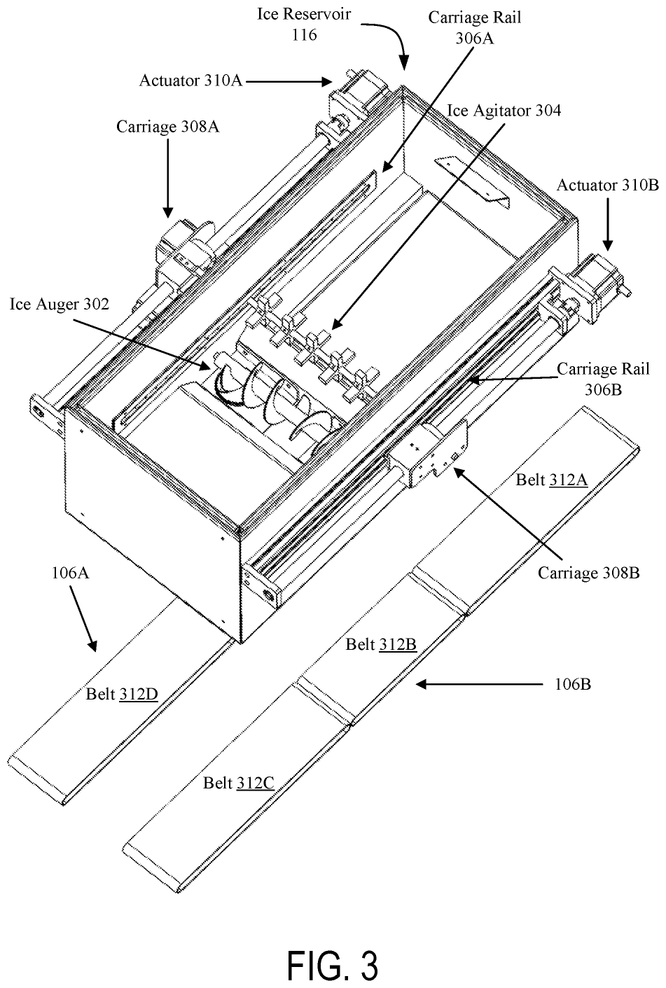

Now referring to FIG. 3 and in brief overview, shown is a perspective view illustration of the ice reservoir 116, which can include an ice auger 302, and ice agitator 304, carriage rails 306A and 306B (generally referred to as carriage rails 306), carriages 308A and 308B (generally referred to as carriages 308), actuators 310A and 310B (generally referred to as actuators 310), and belts 312A-312D (generally referred to as belts 312).

Still referring to FIG. 3 and in further detail, the ice auger 302 can grind ice in the ice reservoir 116. The ice auger 302 can be controlled by a processor or by the ice dispenser 114. The ice auger 302 can grind ice of various sizes. The ice auger 302 can grind ice to reduce its size. The ice auger 302 can crush the ice. The ice auger 302 can include blades that spin to crush the ice. The ice agitator 304 can also move around the ice reservoir, such as from a first end to a second end. The ice auger 302 can grind ice into ice cubes. The ice auger 302 can dispense the ice in accordance with the drink order. The ice auger 302 can grind the ice in the ice reservoir 116 such that it is released to the ice dispenser 114.

The ice agitator 304 can move ice within the ice reservoir 116. For example, the ice agitator 304 can move ice to the ice auger 302, which can dispense the ice. In another example, the ice agitator 304 can move the ice from the ice maker (not pictured) to the ice augur 302.

The carriage rails 306 can enable carriages 308 to move along the ice reservoir 116. The carriage rails 306 be disposed along the side of the ice reservoir 116. For example, the carriage rail 306A can be disposed along a first side of the ice reservoir 116, and the carriage rail 306B can be disposed along a second side of the ice reservoir 116, wherein the first side and the second side are on opposite sides.

The carriages 308 can move along the carriage rails 306 to move the ice agitator 304. The carriages 308 can be coupled to the ice agitator 304 such that movement of the carriages causes movement of the ice agitator 304. The carriages 308 can include wheels configured to roll along the carriage rails 306. The carriages can include magnets to magnetically couple to the carriage rails 306.

The actuators 310 can move the carriages 308 along the carriage rails 306. The actuators 310 can provide a force to move the carriage 308. The actuators 310 can actuate responsive to receiving instructions from a processor. The actuators 310 can be coupled to the carriages 308. For example, actuator 310A can actuate carriage 308A, and actuator 310B can actuate carriage 308B. The actuators 310 can actuate the carriages 308 synchronously. In another example, the actuators 310 can magnetize the carriage rails 306 to move the carriages 308. For example, the actuators 310 can apply an electric current to magnetize the carriage rails 306 to cause movement of the carriages 308.

The belts 312 can be a surface to hold the containers that receive ice from the ice dispenser 114 and substances from the nozzle 118. The belts 312 can include rubber or any other non-slip material to hold the container. The belts 312 can include additional materials such as a top cover, a carcass, and a bottom cover. The top cover can be configured to receive the container. The carcass can provide linear strength and shape of the belts 312. The carcass can include woven or metal fabric that includes longitudinal cords with particular elasticity and resistance to define a structure of the belt 312. The carcass can include steel, polyester, nylon, cotton, aramid, synthetic fibers, or a combination thereof. The bottom cover of the belt 312 can include rubber or plastic compounds that are configured to couple the belt 312 to the belt motor configured to rotate the belt 312.

The belts 312 of the conveyor 106 can be configured to move the containers. Each conveyor 106 can include one or more belts 312 such that the conveyor 106 has a modular structure. Each belt can be driven by an independent motor such that each belt can move independently. The motors can receive instructions to rotate from a processor. For example, simultaneously, belt 312A can move an empty container towards belt 312B while belt 312B is stationary to allow filling of a half-empty container by the nozzle 118 while belt 312C moves a full container away from belt 312B and towards a pickup region. The belts can rotate in any direction, and the belts can rotate in opposite directions. For example, belt 312B can rotate backwards to readjust a position of a container while belt 312C rotate forwards to move a container away from the nozzle 118. In another example, if two adjacent belts rotate in the same direction, then the container can move between belts. For example, if a container is on belt 312A, which is moving towards belt 312B, which itself is also moving in the same direction, then the container on belt 312A can eventually make contact with belt 312B and move to belt 312B.

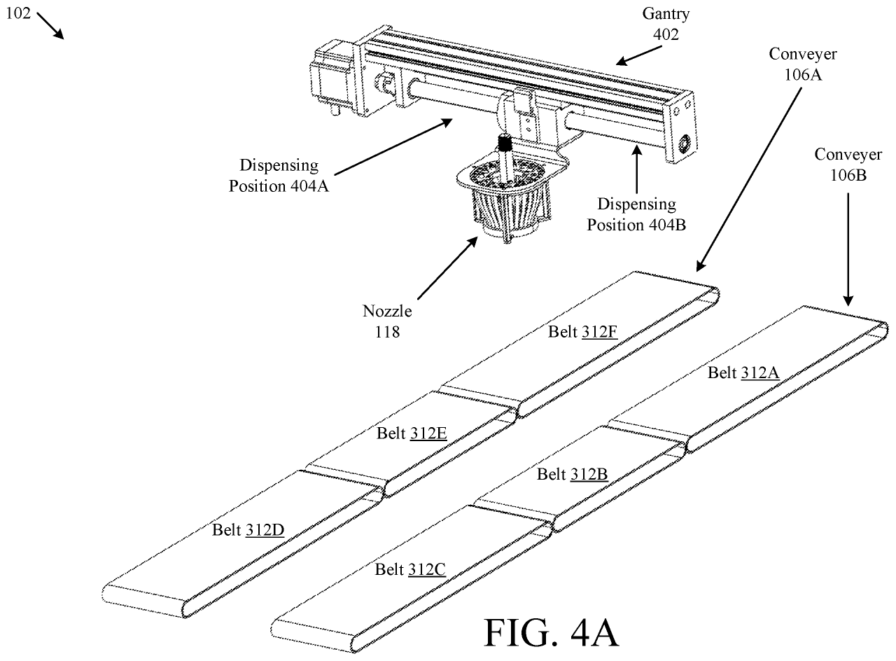

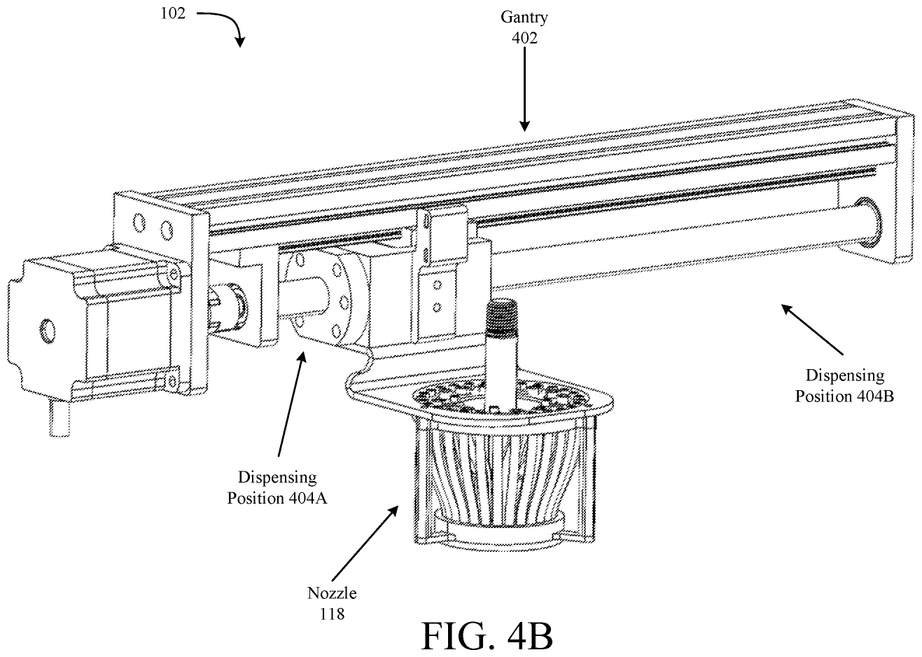

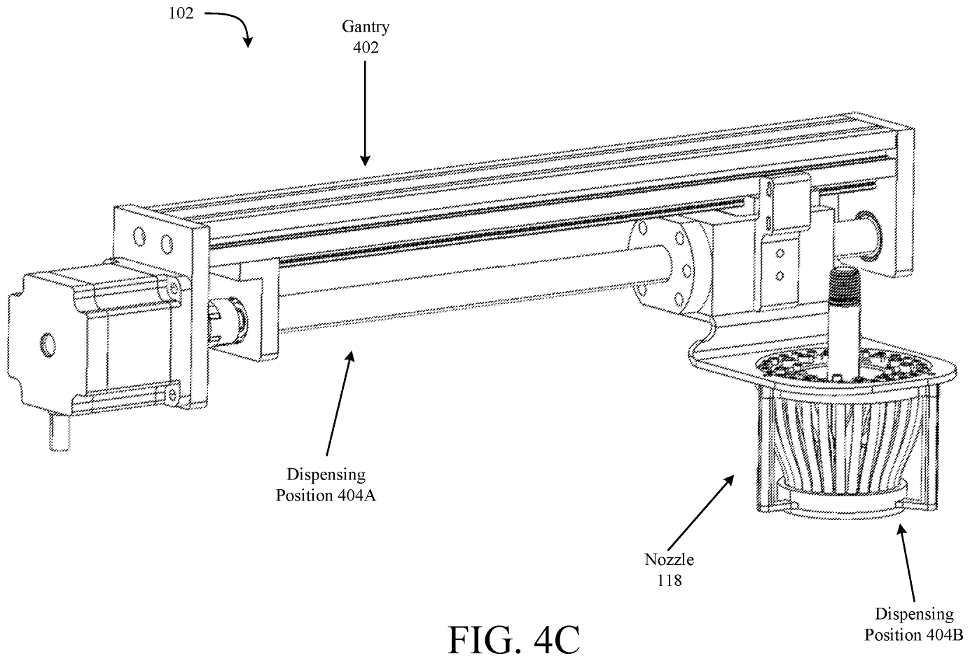

Referring now to FIG. 4A, shown is a cutaway view of one embodiment of a gantry 402 and the nozzle 118. The dispensing unit 102 can include the gantry 402 coupled to the nozzle 118. The gantry 402 may be made of metal, plastic, rubber, and/or composite material. The nozzle 118 may be attached to the gantry 402 by a bracket or other attachment mechanism. Friction may be reduced between the nozzle attachment mechanism and the gantry 402 via ball bearings and/or lubricants. The nozzle 118 may be moved along the gantry by a motor, acting responsive to a processor. The motor may include an electric motor, or any other motor configured to moving the nozzle 118. The motor may be in electrical communication with a processor to receive instructions to move the nozzle 118 to various positions.

The gantry 402 can position the nozzle 118 in dispensing positions 404A and 404B (generally referred to as dispensing positions 404). In some embodiments, the gantry 402 can move the nozzle 118 to the dispensing position 404A or the dispensing position 404B. Referring now to FIG. 4B, shown is a perspective view of the nozzle 118 mounted to the gantry 402 in the dispensing position 404A. Referring now to FIG. 4C, shown is a perspective view of the nozzle 118 mounted to the gantry 402 in the dispensing position 404B. Referring back to FIG. 4A, the nozzle 118 can release liquids at each dispensing position. Each dispensing position 404 can correspond to each conveyor 106. For example, conveyor 106A can convey the containers under the dispensing position 404A and the conveyor 106B can convey the containers to the dispensing position 404B. The nozzle 118 can release a first liquid at the dispensing position 404A and a second liquid at the dispensing position 404B. The gantry 402 can position the nozzle 118 in additional positions to correspond to additional conveyors 106 to scale the system 100.

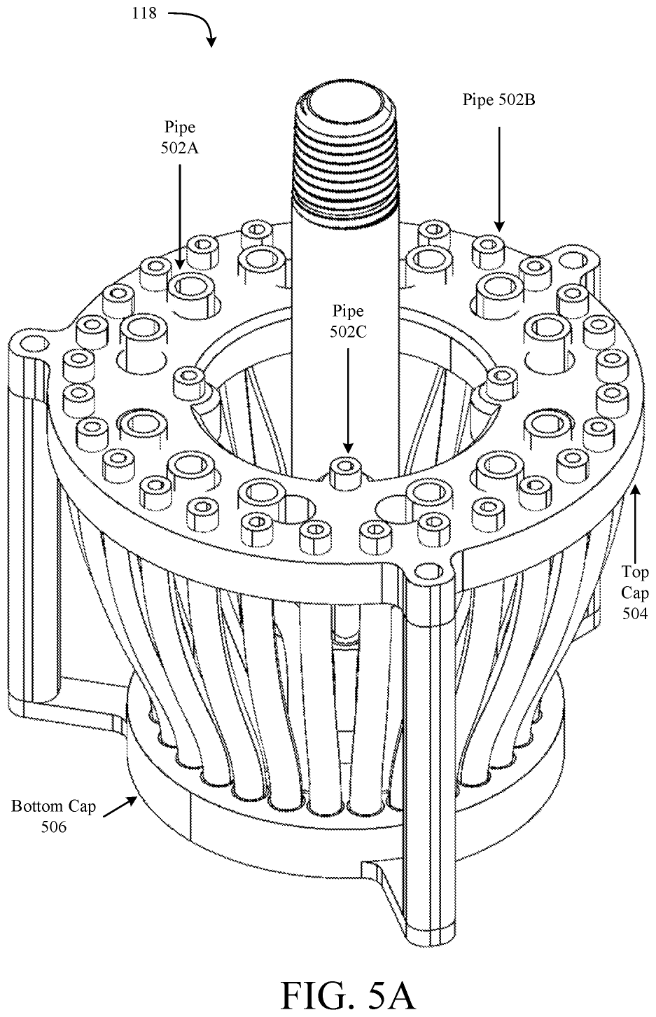

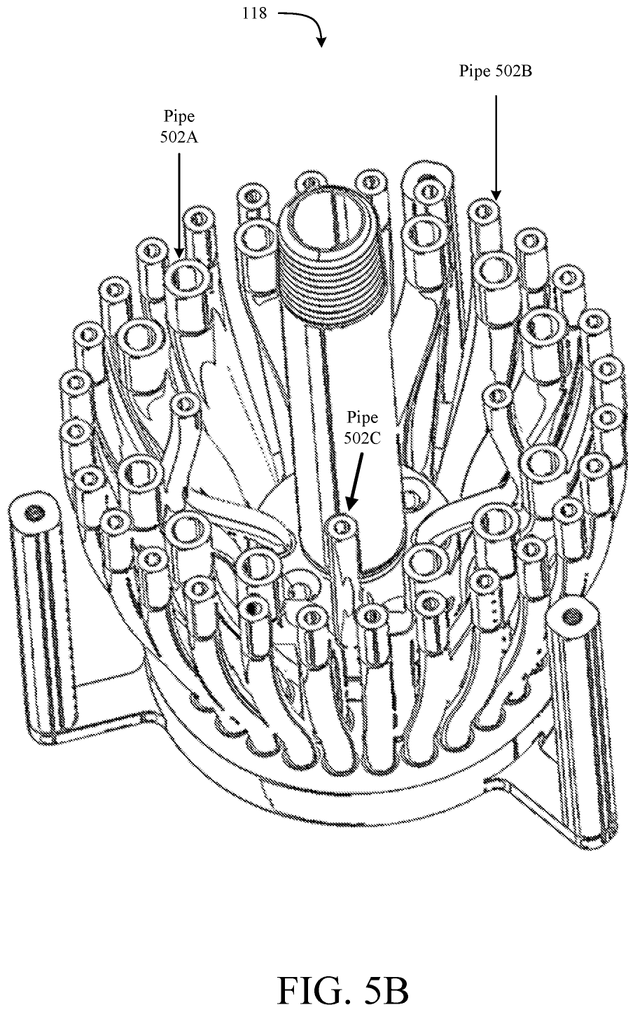

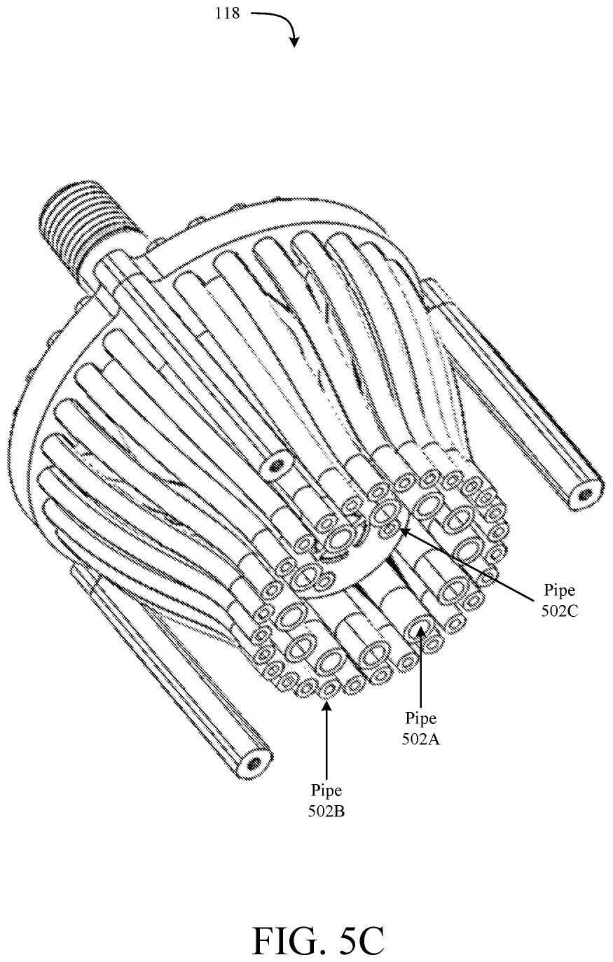

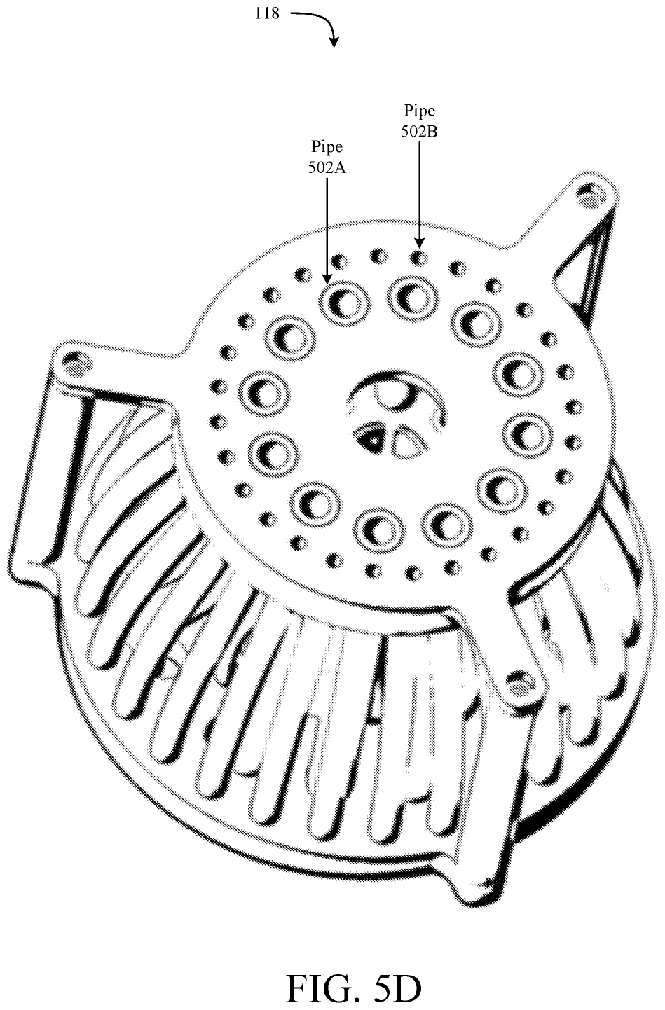

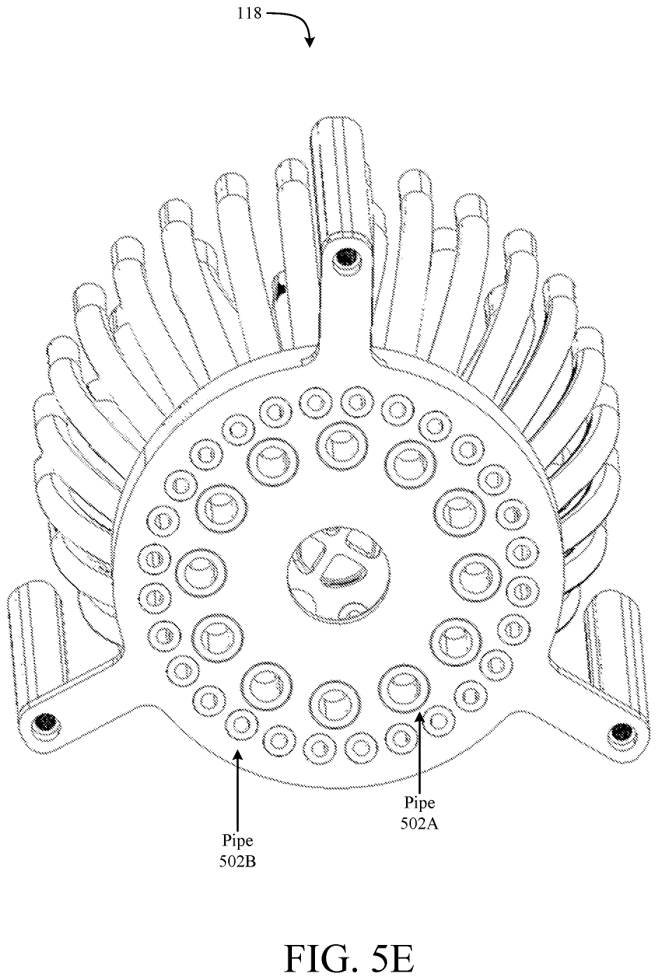

Referring now to FIG. 5A, shown is a top view illustration of a nozzle 118 with pipes 502A-502C (generally referred to as pipes 502) of various sizes. The nozzle 118 can dispense or release liquids. The nozzle 118 can be connected to the pumps 124. The nozzle 118 can dispense different liquids separately such that the liquids are separated until they reach the drink container. The nozzle 118 can receive or retrieve liquids in the receptacles 120 from the pumps 124. Liquids from receptacles 120 can flow through the pipes 502 for release in the dispensing area 110. The pipes 502 can include materials suitable for safely passing liquids intended for human consumption. In some embodiments, the pipes 502 include materials suitable for passing liquids having an alcohol content greater than 10% alcohol by volume. The materials can include plastic or metal. The surface tension and pressure differential of the pipes 502 can prevent the dispensing of liquid from the pipe 502 unless caused by the pump 124. Each pipe 502 can be connected to a respective pump 124. The pipes 502 can have different dimensions such as diameters, width, or lengths. For example, pipe 502A can have a larger diameter than the diameter of the pipe 502B. In some embodiments, pipe 502C has a diameter that is smaller than the dimeter of pipe 502B. The dimensions of the pipes 502 are associated with the type and quantity of liquid that can pass through the pipe. For example, the larger pipe 502A can release juice or other fresh ingredients, the external smaller sized pipe 502B can release liquor, while the interior smaller pipe 502C can release soda syrup. The nozzle 118 can also include a top cap 504 and a bottom cap 506. The top cap 504 and the bottom cap 506 can structurally stabilize and separate the pipes 502 within the nozzle 118. The liquid traverses in the pipes 502 in a direction from the top cap 504 to the bottom 506.

Referring now to FIG. 5B, shown is a top cross sectional view illustration of the nozzle 118 without the top cap 504. The pipes 502 can have different lengths and curvatures. The dimensions of the pipes 502 can be associated with the viscosity and type of liquid dispensed via the pipes 502. Referring now to FIG. 5C, shown is a side cross sectional view illustration of the nozzle 118 without the bottom cap 506, according to some embodiments. Referring now to FIG. 5D, shown is a bottom view illustration of the nozzle 118, according to some embodiments. Referring now to FIG. 5E, shown is a bottom view illustration of the nozzle 118, according to some embodiments.

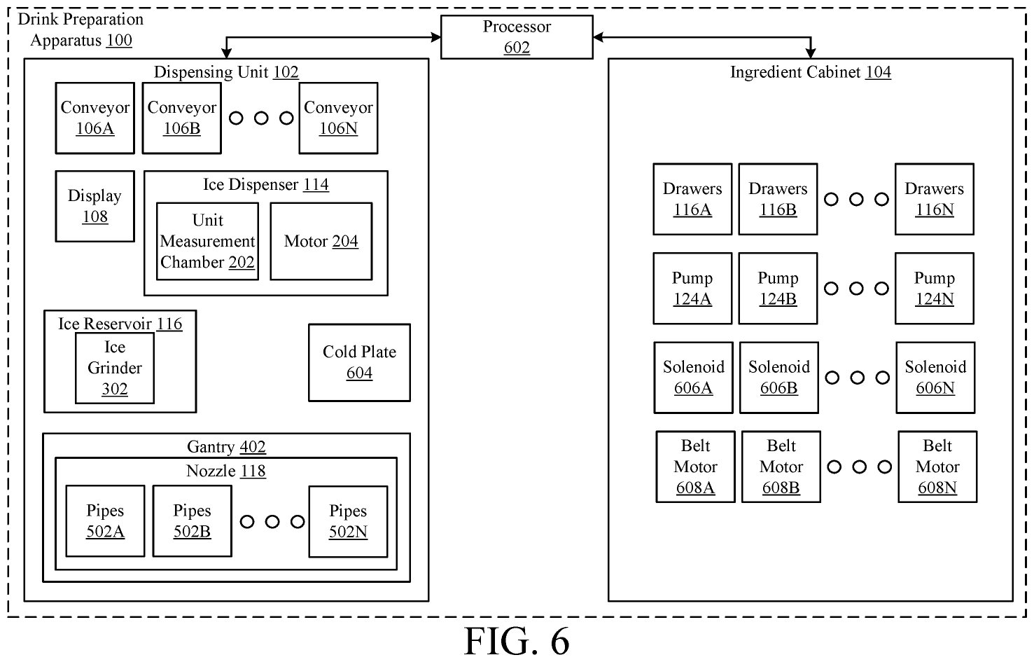

Referring now to FIG. 6 and in brief overview, shown is a system diagram illustrating an embodiment of a drink preparation apparatus 100, according to some embodiments. The drink preparation apparatus 100 can include a processor 602, the dispensing unit 102, and the ingredient cabinet 104. A connecting structure can connect the dispensing unit 102 and the ingredient cabinet 104. The dispensing unit 102 can include the conveyors 106, display 108, ice dispenser 114, the ice reservoir 116, the gantry 402, and a cold plate 604. The ice dispenser 114 can include the unit measurement chamber 202 and the motor 204. The ice reservoir 116 can include the ice auger 302. The gantry 402 can include the nozzle 118, which includes the pipes 502. The ingredient cabinet 104 can include the drawers 112, the pumps 124, the receptacles 120, solenoids 606A-N (generally referred to as solenoids 606), and the belt motors 608A-608N (generally referred to as belt motors 608).

Still referring to FIG. 6 and in further detail, the processor 602 can manage or control the drink preparation apparatus 100. The processor may be coupled to memory, from which the processor 602 can execute instructions or computer programs. The processor 602 can transmit a signal to the conveyors 106, and in particular their motors, to move the containers along on the conveyor to and from the dispensing area 110. The signal can include information relating to which motor to actuate, for how long, and at what speed. The processor 602 can receive drink orders via the display 108. The processor 602 can also display drink orders on the display 108. The processor 602 can transmit instructions to the ice dispenser 114 to cause the ice dispenser 114 to dispense ice. The processor 602 can receive measurements from the unit measurement chamber 202 regarding to an amount of ice dispensed. The processor 602 can transmit instructions to the motor 204 to cause the motor 204 to dispense the ice. The processor 602 can transmit instructions to actuate the motor 204 based on the received measurements. The processor 602 can receive measurements from the ice reservoir 116 relating to a temperature in the ice reservoir 116 or how much ice is stored in the ice reservoir 116. The processor 602 can transmit instructions to the ice auger 302 to grind ice. The instructions can specify how much ice to grind. The processor 602 can transmit instructions to the gantry 402 to cause the gantry 402 to move the nozzle 118 among dispensing positions 404. The processor 602 can receive measurements from the drawers 112. The measurements can indicate a temperature in the drawer 112 or a quantity of each liquid in the drawer 112. In some embodiments, the processor 602 is in electrical communication with the plurality of pumps 124. For example, the processor 602 can select specific pumps 124 to activate. For example, the processor 602 can execute instructions that specify a particular pump 124 to actuate, and then actuate the specified pump 124. The processor 602 can also select pumping speed or flow rate for the pumps 124. In some embodiments, the processor 602 activates one of the plurality of peristaltic pumps 124 to cause liquid to flow through the one of the pipes 502 associated with the one of the plurality of peristaltic pumps 124 and to be dispensed from the one of the first and second plurality of pipes 502 in fluid communication with the one of the plurality of liquid pipes.

The cold plate 604 can cool the liquids or the water/soda system hooked up to the machine as they flow through the dispensing unit 102. The cold plate 604 can be any temperature management system safe for drink preparation. The cold plate 604 can include thermal management techniques such as coolers, fans, Freon, heat sinks, or any other mechanism to reduce the temperature of the liquids as they flow through the dispensing unit 102. The cold plate 604 can include internal cooling lines in a cast aluminum block which sits in an ice bin. The cold plate 604 can be controlled based on instructions received from the processor 602.

The solenoids 606 can be a solenoid valve to control, regulate, or manage the flow of the liquids in the drink preparation apparatus 100. For example, the solenoids 606 can regulate the flow of liquids between the nozzle 118 and the pumps 124. The solenoids 606 can be electro-mechanical valves. The solenoids 606 can include a valve orifice to allow or block the flow of liquids. The solenoids 606 can regulate liquids with low flow capacities or low-pressure differentials between the nozzle 118 and the pumps 124. The solenoids 606 can be pilot operated or direct acting. Solenoids 606 that are pilot operated can utilize the pressure in the liquid line between the nozzle 118 and the pump 124 to regulate the flow of liquids. The solenoids 606 that are direct acting can open or close the orifice in the solenoid 606 to regulate the flow of liquids. The solenoids 606 can include a coil, a plunger, and a sleeve assembly. The solenoids 606 can open or close the orifice by raising or lowering the sleeve by modulating the current in the coil. For solenoids 606 with valves that are typically open, energizing the coil with current causes the plunger to seal the orifice to prevent flow. Conversely, for solenoids 606 with valves that are typically closed, a plunger return spring of the plunger holds the plunger against the orifice to prevent flow, so energizing the coil creates a magnetic field that raises the plunger to open the sleeve to allow flow. The processor 602 can control the solenoids 606 by transmitting instructions to the solenoids 606. For example, the solenoids 606 can open or close the valve response to receiving an instructions from the processor 602 to do so.

The belt motors 608 (or stepper motors) can move or rotate the belts 312 to convey the containers on the belt 312. The processor 602 can transmit a signal to the belt motors 608 to move the containers along on the belt to and from the dispensing region 110. The signal can include information relating to which belt motors 608 to actuate, for how long, and at what speed. The belt motors 608 can rotate a pulley to move the belts 312. The belt motors 608 can be a direct current electric motor. The belt motors 608 can receive voltage and convert it to rotations of the shaft coupled to the pulley to move the belts 312. The belt motors 608 can include electromagnets that divide the rotations of the belt motors 608 into steps. The belt motors 608 then generate current to energize the electromagnet corresponding to each step to rotate a shaft of the belt motors 608 through the steps to rotate the pulley to move the belts 312. The belt motors 608 can also keep a particular electromagnet energized to maintain the shaft in the corresponding position and thus maintain the position of the belts 312. For example, the belt motors 608 can maintain the position of the belts 312 when the container is under the ice dispenser 114 or the nozzle 118 to receive ice or substance, respectively.

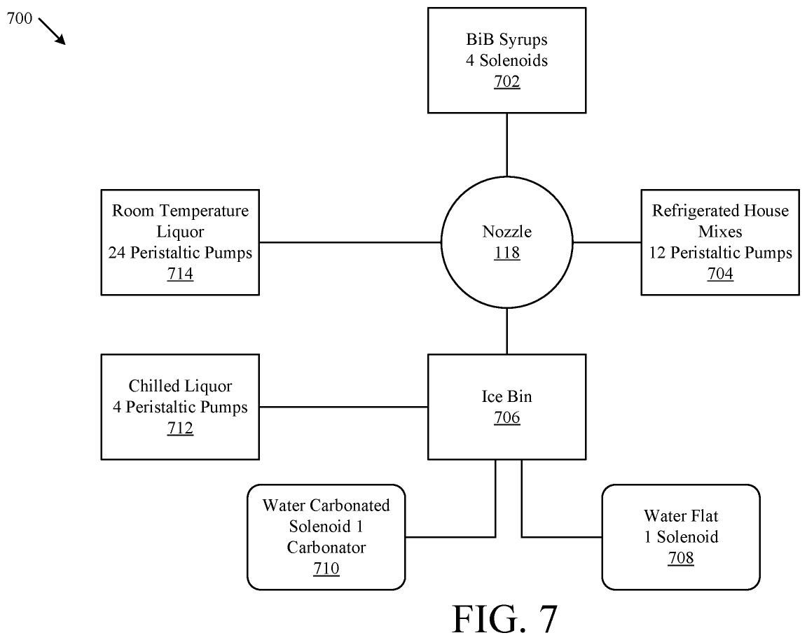

Referring now to FIG. 7, shown is a block diagram illustrating an environment 700 for dispensing liquids from the nozzle 118 to make mixed drinks, according to some embodiments. The nozzle 118 can be coupled to BiB Syrups regulated by four solenoids (702). The nozzle 118 can fluidly connect to refrigerated house mixes regulated by twelve pumps 124 (704). The nozzle 118 can fluidly connect to an ice bin for cooling liquids in the receptacles 120 (706). The ice bin can fluidly connect to flat water that regulated by a solenoid 606 (708). The water can be from a water supply line. The ice bin can fluidly connect to carbonated water regulated by a solenoid 606 and a carbonator (710). The ice bin can fluidly connect to chilled liquor regulated by four pumps 124 (712). The nozzle 118 can fluidly connect to room temperate liquor regulated by twenty-four pumps 124 (714).

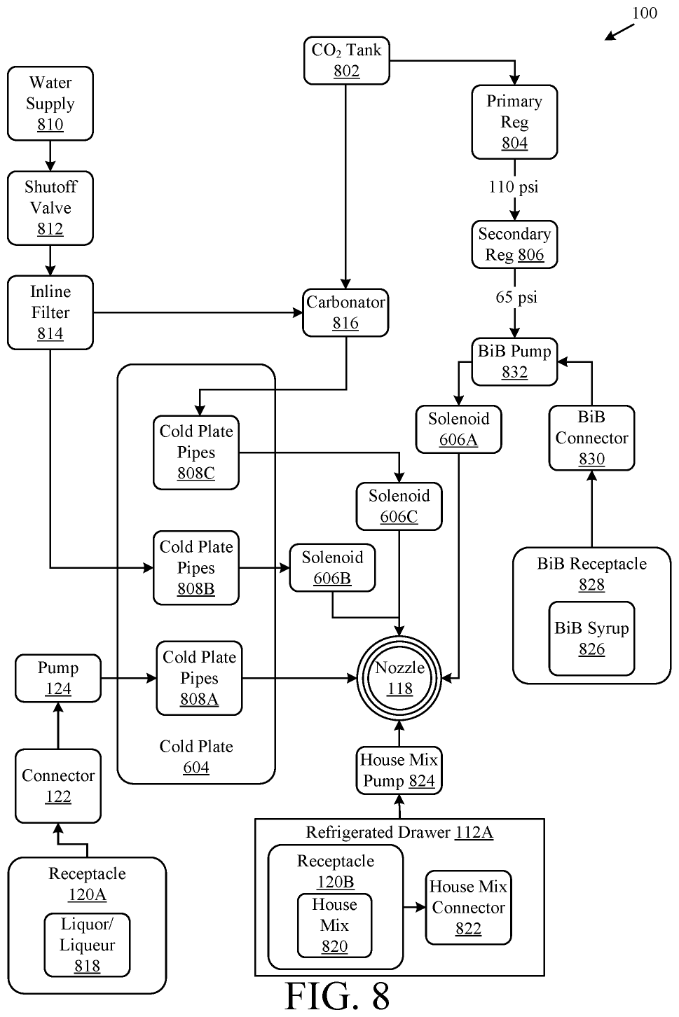

Referring now to FIG. 8 and in brief overview, shown is a block diagram illustrating an embodiment of receptacles 120 fluidly coupled to the nozzle 118. The apparatus 100 can include the cold plate 604, a CO₂ tank 802, a primary regulator 804, a secondary regulator 806, cold plate pipes 808A-808C (generally referred to as cold plate pipes 808), a water supply 810, a shutoff valve 812, an inline filter 814, a carbonator 816, liquor 818, house mix 820, house mix connector 822, house mix pump 824, BiB syrup 826, BiB receptacle 828, BiB connector 830, and BiB pump 832.

The CO₂ tank 802 can be configured to store and release CO₂ that is safe for human consumption in a drink. The CO₂ tank 802 can be external to the dispensing unit 102 and ingredient cabinet 104.

The primary regulator 804 can regulate or control the pressure of the CO₂ released from the CO₂ tank 802. The primary regulator 804 can be a first stage of a two-stage pressure regulator for the CO₂ tank 802. The primary regulator 804 can include valves, springs, or diaphragm configured to reduce the pressure of CO₂ gas. The primary regulator 804 can reduce the CO₂ to a pressure of 110 PSI. In some embodiments, the primary regulator 804 can reduce the CO₂ to a pressure of 50 PSI, 65 PSI, or 100 PSI.

The secondary regulator 806 can regulate or control the pressure of the CO₂ released from the primary regulator 804. The primary regulator 804 can be a second stage of the two-stage pressure regulator for the CO₂ tank 802. For example, the secondary regulator 806 can receive the CO₂ at a pressure of 110 PSI. The secondary regulator 806 can include valves, springs, or diaphragm configured to reduce the pressure of CO₂ gas. In some embodiments, the secondary regulator 806 can reduce the CO₂ to a pressure of 65 PSI. In some embodiments, the primary regulator 804 can reduce the CO₂ to a pressure of 75 PSI, 65 PSI, or 55 PSI.

The cold plate 604 can include cold plate pipes 808 in which the liquids can be cooled. The cold plate pipes 808 can be tubes or regions for the liquids to flow. In some embodiments, the cold plate pipes 808 are tunnels that enable the pipes between the nozzle 118 and the pump 124A to traverse through the cold plate pipe 808 to prevent direct contact between the receptacles 120 and the cold plate 604.

The water supply 810 can be a hose or pipe with water, tap water, filtered water, or any other water safe for human consumption. The water supply 810 can couple to an external water line to introduce the water into the apparatus 100.

The shutoff valve 812 can regulate the flow of water from the water supply 810. The shutoff valve 812 can allow or prevent the water from entering the apparatus 100. The processor 602 can transmit a signal to the shutoff valve 812 to regulate the flow of water from the water supply 810. The signal can include information relating to whether to open, close, or partially open the shutoff valve 812 to regulate the flow of the water from the water supply 810.

The inline filter 814 can filter the water from the water supply 810. The inline filter 814 can be a water filter for removing impurities to lower the contamination of water. The inline filter 814 can include a physical barrier, a chemical process, or a biological process. The inline filter 814 can cleanse the water to make it safe for human consumption. The inline filter 814 can also cleanse the water so that it does not cause the apparatus 100 to malfunction (e.g., clogged from dirty water). The processor 602 can communicate with the inline filter 814. For example, the processor 602 can monitor water quality indicators, how much water the inline filter 814 has cleaned, and a status of the inline filter 814 (e.g., whether or not it needs to be replaced). The cleansed water can flow from the inline filter 814 to the cold plate pipe 808B, and into the solenoid 606B. The solenoid 606B can regulate the flow of the water. The processor 602 can also transmit a signal to the solenoid 606B to modulate the flow of the water. The water that passes through the solenoid 606B exits from the nozzle 118.

The cleansed water can also flow from the inline filter 814 to the carbonator 816. The carbonator 816 can introduce CO₂ gas into the water to create carbonated water. The carbonator 816 can receive the CO₂ gas from the CO₂ tank 802. For example, the signal can include a quantity of CO₂ gas to introduce into the water. The carbonated water can then flow from the carbonator 816 to the cold plate pipe 808C, and into the solenoid 606C. The solenoid 606C can regulate the flow of the carbonated water. The processor 602 can also transmit a signal to the solenoid 606C to modulate the flow of the carbonated water. The carbonated water that passes through the solenoid 606C exits from the nozzle 118.

The pump 124 can pump the liquor/liqueur 818. The pump 124 can pump the liquor/liqueur 818 into the cold plate 604 through the cold plate pipe 808A and to the nozzle 118 for dispensing into the dispensing area 110. The liquor 818 can include vodka, whiskey, rum, or any other alcoholic beverage. The processor 602 can transmit a signal to the pump 124 to pump the liquor/liqueur 818. The signal can include information relating to how much liquor/liqueur 818 to pump and at what flow-rate.

The house mix 820 can include a mixed drink (e.g., daily special, branded drink, etc.) made by the establishment, such as the restaurant or bar. For example, the house mix 820 can include alcoholic ingredients such as vodka or whiskey, or non-alcoholic ingredients such as juice. The refrigerated drawer 112A can store the receptacle 120B, which can include the house mix 820.

The receptacle 120B can connect to the house mix connector 822. The house mix connector 822 can be a port, fastener, barb, or any other fitting that can connect with different receptacles 120. The connectors 822 can be metal, rubber, or plastic. In some embodiments, the receptacle 120B can store 1 gallon of the house mix 820.

The house mix pump 824 can pump, via the house mix connector 822, the house mix 820 to the nozzle 118 for dispensing into the containers. The processor 602 can transmit a signal to the pump 824 to pump the house mix 820. The signal can include information relating to how much house mix 820 to pump and at what flow-rate.

The BiB syrup 826 can include sugary liquid for dispensing into the containers to make the drinks. The BiB syrup 826 can be a thick or viscous fluid to make sugary drinks. The BiB syrup 826 can be prepared for restaurants or bars.

The BiB receptacle 828 can be configured to store the BiB syrup 826. The BiB receptacle 828 can include a bottle or a box configured to store the BiB syrup 826. The BiB receptacle 828 can include any quantity of BiB syrup 826, such as 2 gallons or 5 gallons. The quantity or volume of BiB syrup 826 can be provided to the processor 602 via sensors.

The BiB receptacle 828 can connect to the BiB connector 830. The BiB connector 830 can be ports, fasteners, barbs, or any other fitting that can connect with different receptacles 822. The BiB connector 830 can be metal, rubber, or plastic.

The BiB pump 832 can receive the CO₂ from the secondary regulator 806. For example, the BiB pump 832 can receive the CO₂ with a pressure of 65 PSI. The BiB pump 832 can receive the BiB syrup 826 via the BiB connector 830 fluidly coupled to the BiB receptacle 828. The BiB pump 832 can pump the BiB syrup 826 with the CO₂ to the nozzle 118 for dispensing into the dispensing area 110. The processor 602 can transmit a signal to the BiB pump 832 to pump the BiB syrup 826. The signal can include information relating to how much BiB syrup 826 and CO₂ gas to pump and at what flow-rate.

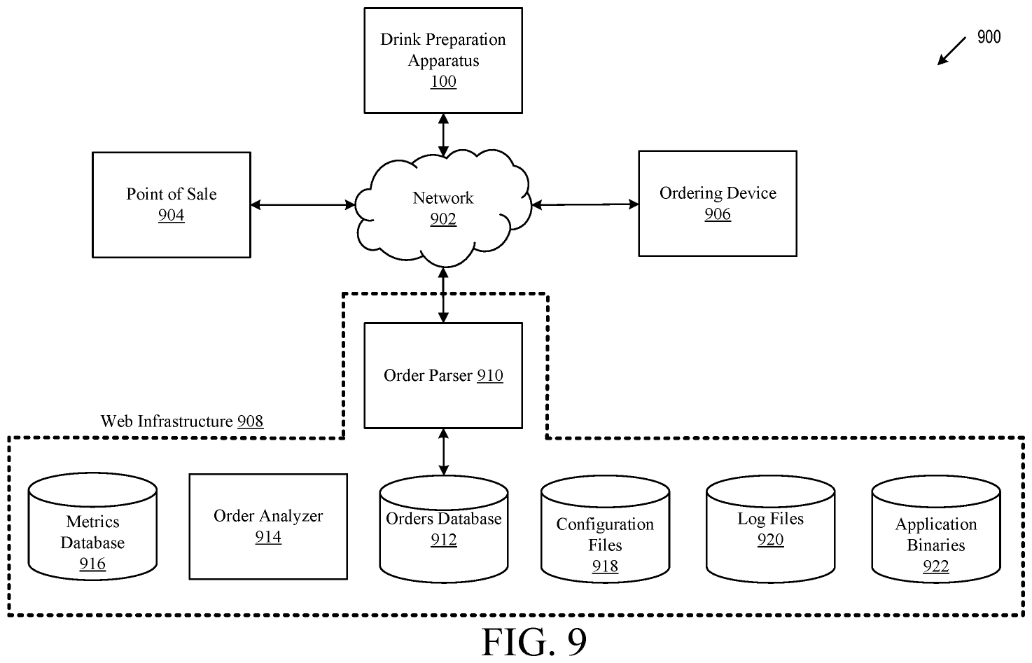

Now referring to FIG. 9 and in brief overview, shown is a block diagram illustrating an embodiment of a drink preparation apparatus 100 in a networking environment 900. The networking environment 900 can include the drink preparation apparatus 100, a network 902, a point-of-sale (POS) system 904, an ordering device 906, and a web infrastructure 908. The web infrastructure 908 can include an order parser 910, an orders database 912, an order analyzer 914, a metrics database 916, configuration files 918, log files 920, and application binaries 922.

Still referring to FIG. 9 and in further detail, the network 902 can include any computer network with communication protocols for managing communications among the web infrastructure 908, the POS system 904, and the ordering device 906. The network 902 can include a local network in an establishment such as restaurant, bar, or stadium. For example, the web infrastructure 908, the POS system 904, and the ordering device 906 can communicate within the restaurant, the bar, or the stadium. The web infrastructure 908, the POS system 904, and the ordering device 906 can communicate within the private network via NFC, Bluetooth, and Wi-Fi direct. The network 902 can also be a public network managed by a telecommunications entity. For example, the web infrastructure 908, the POS system 904, and the ordering device 906 can communicate via a cellular connection.

The POS system 904 can receive or process drink orders for the drink preparation apparatus 100. The POS system 904 can be a checkout counter, a cash register, or any system managed by the establishment for interfacing with the users. The POS system 904 can include software or hardware for receiving or processing the drink orders. For example, the POS system 904 can include an input device for the user to input their drink order. The POS system 904 can receive specifics for the order, such as drink type, liquids, and quantity. The POS system 904 can also request and receive payment from the user to process the order. The POS system 904 can transmit the order to the web infrastructure 908 via the network 902.

The ordering device 906 can receive or process drink orders for the drink preparation apparatus 100. The ordering device 906 can include a tablet computer or mobile device provided by the establishment to each customer. The ordering device 906 can be a user's personal mobile device with a mobile application provided by the establishment. The customers can provide drink orders via the ordering device 906. The ordering device 906 can receive specifics for the order, such as drink type, liquids, and quantity. The ordering device 906 can also request and receive payment from the user to process the order. The ordering device 906 can transmit the order to the web infrastructure 908 via the network 902.

The web infrastructure 908 can receive, parse, and process the drink orders from users of the drink preparation apparatus 100. The web infrastructure 908 can include software or hardware. The web infrastructure 908 can communicate with the drink preparation apparatus 100 to transmit or receive information relating to the orders. The web infrastructure 908 can transmit and receive information relating to the orders via the network 902 to the POS system 904 and the ordering device 906. The web infrastructure 908 can store or parse information relating to the users, drink orders, inventory, payment methods, and order fulfillment.

The order parser 910 can parse or identify orders from the POS system 904 or the ordering device 906. The order parser 910 can parse the order to identify the type of drink, liquids, glass type, or any other order specifics or requests. The order parser 910 can store the parsed order in the orders database 912.

The orders database 912 can be a database that can store the parsed order from the order parser 910. The orders database 912 can include a local or networked storage. The orders database 912 can store the orders in tables, text files, or in any other file. The orders database 912 can store specifics of the parsed orders as text strings, codes, or any other format.

The order analyzer 914 can analyze the orders in the orders database 912 to determine or identify information relating to the orders. The information can include contextual information of the order such as time, location, or demographics of the user. The order analyzer 914 can use the information to determine whether to transmit the order to the drink preparation apparatus 100 or delete the order. For example, the order analyzer 914 can delete orders that are associated with information that does not comply with laws relating to drink orders (e.g., drink quantity, customer age, and order time). Conversely, if the order complies with laws, then the order analyzer 914 can transmit the order to the drink preparation apparatus 100.

The order analyzer 914 can also apply statistical tools and analysis (e.g., statistical modeling) to the orders to determine, identify, or calculate metrics. The metrics can include order patterns for the POS system 904 or the ordering device 906. For example, the metrics can indicate frequencies of and associations among drink types, order times, and quantities at the POS system 904. Similarly, the metrics can indicate frequencies of and associations among drink types, order times, and quantities at each ordering device 906 (e.g., correlate waiter sales performance based on order activity arising from their ordering device 906). Based on the metrics, the order analyzer 914 can identify patterns (e.g., correlation) for predicting drink orders. For example, the order analyzer 914 can identify liquids (e.g., whiskey) that are expected to be ordered at certain times (e.g., 11 pm) from certain users or waiters (e.g., ordering device 906), and transmit a signal to the drink preparation apparatus 100 to recommend stocking those liquids to satisfy the expected orders for them. The order analyzer 914 can store the metrics and corresponding analysis in the metrics database 916.

The metrics database 916 can be a database that can store the metrics and statistical analysis from the order analyzer 914. The metrics database 916 can include a local or networked storage. The metrics database 916 can store the metrics in tables, graphs, text files, or in any other file. The metrics database 916 can store the metrics as text strings, codes, or any other format.

The configuration files 918 can include configurations, settings, or information for the drink preparation apparatus 100. An administrator can load the configuration files 918 for transmission to the drink preparation apparatus 100. For example, the configuration files 918 can include permissions for handling drink orders received on the drink preparation apparatus 100 (e.g., via the screen 108). Examples of permissions include that the drink preparation apparatus 100 can use certain liquids (e.g., beer but not whiskey), that the drink preparation apparatus 100 can only dispense 50 mL of 40% liquor per drink order, or that the drink preparation apparatus 100 cannot accept more than three alcoholic drinks in one order.

The log files 920 include information relating to the drink preparation apparatus 100. The drink preparation apparatus 100 can provide the information for storage as the log files 920. The information can include time stamps relating to drink dispensing, quantity and type of drink dispensing, inventory levels of liquids, error messages, service logs, or status of the inline filter 814.

The application binaries 922 can include software, firmware, or configurations relating to the drink preparation apparatus 100. The application binaries 922 can include software for the GUI presented on the display 108. The application binaries 922 can include drivers for interfacing with the sensors of the drink preparation apparatus 100. An administrator can load the application binaries 922 for transmission to the drink preparation apparatus 100.

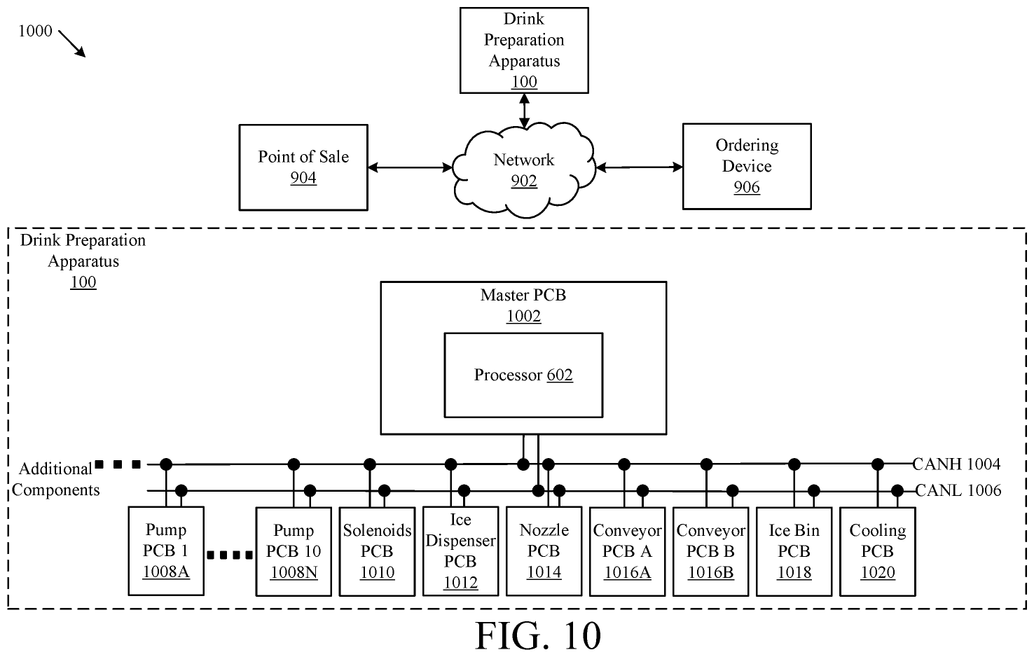

Referring now to FIG. 10, shown is a block diagram illustrating an embodiment of an environment 1000. The environment 1000 can include a master PCB 1002, a CAN high (CANH) 1004, CAN low (CANL) 1006, pump PCB 1008A-1008N (generally referred to as pump PCB 1008), solenoids PCB 1010, ice dispenser PCB 1012, nozzle PCB 1014, conveyor PCB 1016A and 1016B (generally referred to as conveyor PCB 1016), ice bin PCB 1018, and cooling PCB 1020.

Still referring to FIG. 10 and in further detail, the master PCB 1002 can be an embedded controller with a printed circuit board that connects to the components of the drink preparation apparatus 100. The processor 602 can communicate with the master PCB 1002, such as via a USB Interface. The processor 602 and the master PCB 1002 can communicate and exchange messages or instructions to control or manage the drink preparation apparatus 100. The master PCB 1002 can include a controller area network (CAN bus) that uses signals CANH 1004 or CANL 1006 to drive the components between an active high signal or active low signal, respectively. The components can include at least the pump PCB 1008, solenoids PCB 1010, ice dispenser PCB 1012, nozzle PCB 1014, conveyor PCB 1016, ice bin PCB 1018, and cooling PCB 1020. Each component can include a connection to the master PCB 1002, and each component can include its own PCB. The pump PCB 1008 can include an electrical connection to drive the pump 124. The solenoids PCB 1010 can include an electrical connection to drive the solenoids 606. The ice dispenser PCB 1012 can include an electrical connection to drive the ice dispenser 114. The nozzle PCB 1014 can include an electrical connection to drive the nozzle 118 or the gantry 402. The conveyor PCB 1016 can include an electrical connection to drive the conveyor 106. The ice bin PCB 1018 can include an electrical connection to drive the ice reservoir 116 or the ice auger 302. The cooling PCB 1020 can include an electrical connection to drive the refrigeration of the ingredient cabinet 104.

The drink preparation apparatus 100 can include power supplies for the pump PCB 1008, solenoids PCB 1010, ice dispenser PCB 1012, nozzle PCB 1014, conveyor PCB 1016, ice bin PCB 1018, and cooling PCB 1020. The drink preparation apparatus 100 can include a 5V buck converter for LED strips of the conveyor PCB 1016 and a 12V buck converter for the screen 108 and/or processor 602. The power supplies can include MEAN WELL LRS-350-24 rated for 24V, 14.6 A, and 350 W. The ingredient cabinet 104 can include dedicated power supplies with subsystems for the pump PCB 1008 and fan drive boards. The power supply for the ingredient cabinet 104 can include MEAN WELL LRS-350-24 rated for 24V, 14.6 A, and 350 W. The power supply for the cooling 1320 can include subsystems such as for the house mix board and specifications for MEAN WELL LRS-350-24 with ratings of 24V, 14.6 A, and 350 W.

The drink preparation apparatus 100 can also include fan drive boards that can deliver 12V power to the various cooling fans distributed throughout the drink preparation apparatus 100. In some embodiments, the drink preparation apparatus 100 can include two fan drive boards. There are fans within the house mix drawer, fixed to the Peltier device heatsinks, and fixed to the outer frame of the lower unit. The fan drive boards can distribute power passively to the fans. The fan drive boards can include a power supply, which can include 1×2P 5 mm Screw Terminal (12V Power In) and automotive mini blade fuse (ATM) holder up to 2 A. The fan drive boards can include 12× Fan Connectors, which can include 3-pin Molex KK 254 connector and 4 connectors per side for soldering or connecting to any position.

The master PCB 1002 can receive drinks orders from the processor 602 and directs the actions of the other boards or components 1308-1320 via a CAN bus. The master PCB 1002 can include an onboard co-processor for monitoring the CAN bus and flashing firmware to other boards via CAN. The master PCB 1002 can include a first microcontroller such as an ATmega2560 @ 16 MHz. The microcontroller can include an ICSP Programming Header, a Reset Button, and pins. The pins can include MISO, MOSI, SCK, and RST. The master PCB 1002 can include a second microcontroller 2 such as an ATmega328P @ 16 MHz. The second microcontroller includes an ICSP Programming Header, a reset Button, and pins. The pins can include MISO, MOSI, SCK, and RST. The master PCB 1002 can include a power supply. The power supply can include a 24V to 5V Regulator, a 24V to 3.3V Regulator, 2×3P 2.54 mm Pin Headers (+24V & GND), 3P 2.54 mm Header for supplying external power, 100 mA PTC Resettable Fuse. The master PCB 1002 can include 2×CAN Interfaces that can include an MCP2515 Controller @ 16 MHz, a TJA1050 Transceiver, a 2P 2.54 mm Pin Header, a RC CAN Termination Network, a first set of pins corresponding to the first microcontroller (MISO, MOSI, SCK, PB0 (CAN_CS line), or PE6 (INT6)), and a second set of pins corresponding to the second microcontroller (MISO, MOSI, SCK, PB2 (CAN_CS line), PD2 (INTO). The master PCB 1002 can include a USB Tablet Interface, which can include a FT232RL USB-UART bridge, a USB Type B Port, and pins corresponding to the first microcontroller (TXD0, RXD0). The master PCB 1002 can include a USB Debug Interface, which can include a FT232RL USB-UART bridge, Micro USB Port, and pins corresponding to the first microcontroller (TXD1, RXD1). The master PCB 1002 can include a USB Snooper Interface, which can include a FT232RL USB-UART bridge, a Micro USB Port, and pins corresponding to the second microcontroller (TXD, RXD). The master PCB 1002 can include a Real-Time Clock, which can include a DS3231 RTC, a CR2032 Coin Cell Holder, and pins corresponding to the first microcontroller (SDA, SCL, and INTn). The master PCB 1002 can include a Micro SD Card Module, which can include a microSD Card Socket, 5V to 3.3V Level Shifters, and pins corresponding to the first microcontroller (MISO, MOSI, SCK, Pxx (SD CS pin), Pxx (SD CD pin).

The master PCB 1002 can include an upper right board that can provide power, CAN bus, and I/O breakout connections to the master PCB 1002, ice bin PCB 1018, nozzle PCB 1014, and solenoids PCB 1010. The upper right board can be on the right-hand side of the dispensing unit 102. The upper right boards can be mounted to the master PCB 1002. The upper right board can include a power supply, which can include a 2×2P 5 mm right angle pluggable terminal block +24V in & out, and 2×2P 5 mm right angle pluggable terminal block with GND in & out. The upper right board can include a CAN Interface with a 2×8P8C (RJ45) Jack and CAN in & out. The upper right board can include 4×Board-to-board mezzanine connector sets for pump boards, which can include 24V Power with 5P 2.54 mm header for +24V and 5P 2.54 mm header for GND, a CAN Bus with 2P 2.54 mm header, 4× Stepper Drives with 2×4P 2.54 mm header, 4× Liquid Detection Sensors and 4P 2.54 mm header, and 4× Limit Switches with a 2P 2.54 mm header. The upper right board can include 4×Wire-to-board connector sets for external I/O, which can include 4×Stepper Drives with 4P 3.5 mm vertical pluggable terminal block, 4× Liquid Detection Sensors with 4P 3.5 mm vertical pluggable terminal block, 4× Limit Switches with 2P 3.5 mm vertical pluggable terminal block. The upper right board can include 5× automotive mini blade fuse (ATM) holders, which can include 4× for individual PCBs up to 10 A and 1× for entire board up to 25 A.

The master PCB 1002 can include an upper left board that can provide power, CAN bus, and I/O breakout connections to the two conveyor PCBs and the ice dispenser PCB 1012 on the left hand side of the machine's dispensing unit (e.g., dispensing unit 102). The upper left boards can be mounted to the master PCB 1002. The upper left board can include a power supply, which can include a 2×2P 5 mm right angle pluggable terminal block up to +24V in & out and 2×2P 5 mm right angle pluggable terminal block up to GND in & out. The upper right board can include a CAN interface, which can include 2×8P8C (RJ45) jack to CAN in & out, 2× Board-to-board mezzanine connector sets for conveyor boards, 24V power, 5P 2.54 mm header for +24V, 5P 2.54 mm header for GND, a CAN bus with 2P 2.54 mm header, 4× stepper drives with 2×4P 2.54 mm header, an IR Emitter/Receiver Pair with 2P 2.54 mm header and 3P 2.54 mm header, 4× laser indicators pairs with 2×2P 2.54 mm header, and LED Strip Data with 2P 2.54 mm header. The upper right board can include a 2×5V DC/DC Step-down Converter. The upper right board can include 2× Wire-to-board connector sets for conveyor external I/O with 4× Stepper Drives with 4P 3.5 mm with vertical pluggable terminal block, IR Emitter/Receiver Pair with 2P 3.5 mm vertical pluggable terminal block and 3P 3.5 mm vertical pluggable terminal block, 4× laser indicators pairs with 4P 3.5 mm vertical pluggable terminal block, and an LED Strip with 4P 3.5 mm vertical pluggable terminal block. The upper right board can include 1× Board-to-board mezzanine connector sets for ice dispenser board, which can include 24V Power, 5P 2.54 mm header for +24V, 5P 2.54 mm header for GND, CAN Bus with 2P 2.54 mm header, 2×BLDC drives with 2×6P 2.54 mm header and 5P 2.54 mm header, and 2× hall switches with 3P 2.54 mm header. The upper right board can include 1× Wire-to-board connector sets for ice dispenser external I/O with 2×BLDC Drives with 3P 5 mm with vertical pluggable terminal block and 5P 3.5 mm vertical pluggable terminal block, and 2× Hall Switches with 3P 3.5 mm vertical pluggable terminal block. The upper right board can include 4× automotive mini blade fuse (ATM) holders with 2× for conveyor PCBs up to 5 A, 1× for ice dispenser PCB up to 20 A, and 1× for entire board up to 25 A.

The solenoids PCB 1010 can control the solenoid valves 704, such as the BiB syrups used in soft drink mixers. The master PCB 1002 can manage the solenoids PCB 1010 via the CAN bus. The solenoids PCB 1010 can include a microcontroller, which can include an ATmega328P @ 16 MHz, ICSP programming header, a serial header, a reset button, and pins (MISO, MOSI, SCK, RST, TXD, and RXD). The solenoids PCB 1010 can include a power supply, which can include a 24V to 5V Regulator and 2×5P 2.54 mm Pin Headers (+24V & GND). The solenoids PCB 1010 can include a CAN interface a MCP2515 Controller @ 16 MHz, TJA1050 Transceiver, 2P 2.54 mm Pin Header, pins (MISO, MOSI, SCK, PB2 (CAN_CS line), PD2 (INTO)). The solenoids PCB 1010 can include 4× Solenoid Drive Circuits, which can include a Low-Side Switch, 2P 2.54 mm Pin Header, 24 VDC, and 5.5 W solenoid valves, an Indicator LED, and 4×Pxx pins. The solenoids PCB 1010 can include a hardware address circuit, a 74HC165D serial shift register, 8× shunt jumpers (w/pull-up resistors), and pins (MISO, MOSI, SCK, and Pxx (ADDR_CS line)).

The pump PCB 1008 can control stepper motor-driven peristaltic pumps (e.g., pump 124) that dispense the machine's stored house mixes and liquors (e.g., receptacle 120). The pump PCB 1008 can detect when a liquid has been used up using IR optical sensors connected to the dispensing lines. The pump PCB 1008 can detect when a bottle has been removed from its connector using limit switches attached to the connector. The master PCB 1002 can control the pump PCB 1008 via the CAN bus. The pump PCB 1008 can include a microcontroller ATmega328P @ 16 MHz, which can include an ICSP programming header, serial header, reset button, and pins (MISO, MOSI, SCK, RST, TXD, and RXD). The pump PCB 1008 can include a power supply, which can include a 24V to 5V regulator and 2×5P 2.54 mm pin headers (+24V & GND). The pump PCB 1008 can include a CAN interface which can include a MCP2515 Controller @ 16 MHz, TJA1050 transceiver, optional termination resistors (shunt jumpers), 2P 2.54 mm Pin Header, and pins (MISO, MOSI, SCK, PB2 (CAN_CS line), and PD2 (INTO)). The pump PCB 1008 can include a 16-bit Port Expander (MCP23S17), and pins (MISO, MOSI, SCK, Pxx (IO_CS), and 2×Pxx (INTA & INTB)). The pump PCB 1008 can include 4× stepper motor driver circuits, which can include DRV8825 stepper driver, 2.5 A peak fixed current limit, EN & FAULT indicator LEDs, 2×4P 2.54 mm Pin Headers (to stepper) with NEMA 23 Stepper Motor (1.2 Nm): 2.5 A, and pins (OCOA, OCOB, OC2B, OCIA (STEP), 4×GPAx (DIR), 4×GPAx (EN)). The pump PCB 1008 can include 4× Bubble sensor circuits, which can include 4P 2.54 mm pin header with an IR optical sensor, IR LED cathode & anode, phototransistor collector & emitter, indicator LED circuit with LM393 analog comparator with detection voltage thresholds such that green when liquid is detected and red otherwise, and 4×PCx pins (analog sensor input lines). The pump PCB 1008 can include 4× Bottle Detection Circuits, which can include 2P 2.54 mm Pin Header, Limit switch (using MCP23S17 internal pull-up), and 4×GPBx pins. The pump PCB 1008 can include a hardware address circuit, which can include a 74HC165D serial shift register, 8× shunt jumpers (w/pull-up resistors), and pins (MISO, MOSI, SCK, and RXD (ADDR_CS line).

The pump PCB 1008 can also include a first liquor board that can provide power, CAN bus, and I/O breakout connections to the first four pump boards in the liquor drawer (e.g., drawer 112B). The first liquor board can include a power supply, which can include 2×2P 5 mm right angle pluggable terminal block to +24V in & out and 2×2P 5 mm right angle pluggable terminal block to GND in & out. The first liquor board can include a CAN interface with 2×8P8C (RJ45) jack to CAN in & out. The first liquor board can include 4× Board-to-board mezzanine connector sets for pump boards, which can include 24V Power with 5P 2.54 mm header for +24V and 5P 2.54 mm header for GND, a CAN bus with 2P 2.54 mm header, 4× stepper drives with 2×4P 2.54 mm header, 4× liquid detection sensors with 4P 2.54 mm header, 4× limit switches with 2P 2.54 mm header. The first liquor board can include 4× Wire-to-board connector sets for external I/O, which can include 4× stepper drives with 4P 3.5 mm vertical pluggable terminal block, 4× liquid detection sensors with 4P 3.5 mm vertical pluggable terminal block, 4× limit switches with 2P 3.5 mm vertical pluggable terminal block. The first liquor board can include 5× automotive mini blade fuse (ATM) holders, which can include 4× for individual PCBs up to 10 A and 1× for entire board up to 25 A.

The pump PCB 1008 can also include a second liquor board that can provide power, CAN bus, and I/O breakout connections to the last three pump boards in the liquor drawer (e.g., drawer 112B). The second liquor board can include a power supply, which can include 2×2P 5 mm right angle pluggable terminal block to +24V in & out and 2×2P 5 mm right angle pluggable terminal block to GND in & out. The second liquor board can include a CAN Interface with 1×8P8C (RJ45) jack to CAN in and a termination circuit. The second liquor board can include 4× Board-to-board mezzanine connector sets for pump boards, which can include 24V Power with 5P 2.54 mm header for +24V and 5P 2.54 mm header for GND, a CAN Bus with 2P 2.54 mm header, 4× stepper drives with 2×4P 2.54 mm header, 4× liquid detection sensors with 4P 2.54 mm header, 4× limit switches with 2P 2.54 mm header. The second liquor board can include 4× Wire-to-board connector sets for external I/O, which can include 3× stepper drives with 4P 3.5 mm vertical pluggable terminal block, 4× liquid detection sensors with 4P 3.5 mm vertical pluggable terminal block, 4× limit switches with 2P 3.5 mm vertical pluggable terminal block. The second liquor board can include 4× automotive mini blade fuse (ATM) holders, which can include 3× for individual PCBs up to 10 A and 1× for entire board up to 25 A.

The pump PCB 1008 can also include a house mix board that can provide power, CAN bus, and I/O breakout connections to the three pump boards in the house mix drawer (e.g., drawer 112A). The house mix board can include a power supply, which can include 2×2P 5 mm right angle pluggable terminal block to +24V in & out and 2×2P 5 mm right angle pluggable terminal block to GND in & out. The house mix board can include a CAN Interface with 2×8P8C (RJ45) Jack to CAN in and a termination circuit. The house mix board can include 3× Board-to-board mezzanine connector sets for pump boards, which can include 24V Power with 5P 2.54 mm header for +24V and 5P 2.54 mm header for GND, a CAN Bus with 2P 2.54 mm header, 4× stepper drives with 2×4P 2.54 mm header, 4× liquid detection sensors with 4P 2.54 mm header, 4× limit switches with 2P 2.54 mm header. The second liquor board can include 3× Wire-to-board connector sets for external I/O, which can include 4× stepper drives with 4P 3.5 mm vertical pluggable terminal block and 4× liquid detection sensors with 4P 3.5 mm vertical pluggable terminal block. The second liquor board can include 4× automotive mini blade fuse (ATM) holders, which can include 3× for individual PCBs up to 10 A and 1× for entire board up to 25 A.

The ice dispenser PCB 1012 can control the BLDC-driven ice dispensers (e.g., ice dispenser 114) that dispenses ice into glasses. The ice dispenser PCB 1012 can utilize hall-effect switches to determine the position of the dispenser motors (e.g., motor 204) shafts in 180° increments. The master PCB 1002 can control the ice dispenser PCB 1012 via the CAN bus. The ice dispenser PCB 1012 can include a microcontroller, ATmega328P @ 16 MHz, ICSP programming header, a serial Header, a reset button, and pins (MISO, MOSI, SCK, RST, TXD, RXD). The ice dispenser PCB 1012 can include a power supply, which can include a 24V to 5V Regulator and 2×5P 2.54 mm pin headers (+24V & GND). The ice dispenser PCB 1012 can include a CAN Interface, which can include a MCP2515 Controller @ 16 MHz, a TJA1050 transceiver, 2P 2.54 mm pin header, and pins (MISO, MOSI, SCK, PB2 (CAN_CS line), and PD2 (INTO)). The ice dispenser PCB 1012 can include 2×BLDC motor driver circuits, which can include a A3930 stepper driver, potentiometers to tune current thresholds and/or hardwired resistor based on current thresholds, fault indicator LEDs, 2×6P 2.54 mm pin headers (to BLDC phases), and 5P 2.54 mm Pin Headers (to BLDC hall sensors). The ice dispenser PCB 1012 can include 2×NEMA 23 24V 3500 RPM 0.6 Nm 220 W BLDCs (12.5 A) and pins (OC0A, OC0B (PWM), 2×Pxx (DIR), 2×Pxx (RESET), 2×Pxx (BRAKE), and 2×Pxx (TACHO)) The ice dispenser PCB 1012 can include 2× Hall-effect sensor circuits, 3P 2.54 mm pin headers with Omni polar hall-effect switches (A1126), and 2×Pxx pins.

The nozzle PCB 1014 can control the gantry 402 to move the nozzle 118. The nozzle PCB 1014 can utilize limit switches and a stepper motor to move the nozzle 118 assembly along a linear rail/ball screw. The nozzle PCB 1014 can also control solenoids 606B and 704C for dispensing water and carbonated water. The master PCB 1002 can control the nozzle PCB 1014 via the CAN bus. The nozzle PCB 1014 can include a microcontroller, which can include an ATmega328P @ 16 MHz, an ICSP programming header, a serial header, reset button, pins (MISO, MOSI, SCK, RST, TXD, and RXD). The nozzle PCB 1014 can include a power supply, which can include a 24V to 5V Regulator and 2×5P 2.54 mm Pin Headers (+24V & GND). The nozzle PCB 1014 can include a CAN Interface, which can include a MCP2515 Controller @ 16 MHz, a TJA1050 transceiver, 2P 2.54 mm pin header, and pins (MISO, MOSI, SCK, PB2 (CAN_CS line), and PD2 (INTO)). The nozzle PCB 1014 can include a stepper motor driver circuit, which can include a DRV8825 stepper driver, 2.5 A peak fixed current limit, EN & FAULT indicator LEDs, 2×4P 2.54 mm pin jeaders (to stepper), NEMA 23 stepper motor (1.2 Nm): 2.5 A, and pins (OCOA (STEP), 1×Pxx (DIR), 1×Pxx (EN), 2× Limit Switch Circuit with a pull-up resistor, debounce circuit, an indicator LED, 2P 2.54 mm pin header, mechanical limit switches, and 2×PCx pins. The nozzle PCB 1014 can include 2× solenoid drive circuits, a Low-Side Switch, a 2P 2.54 mm Pin Header, 24 VDC and 5.5 W with an indicator LED for the solenoid valves, and 2×Pxx pins. The nozzle PCB 1014 can include a hardware address circuit with 74HC165D serial shift register, 8× shunt jumpers (w/pull-up resistors), and pins (MISO, MOSI, SCK, Pxx (ADDR_CS line)).

The conveyor PCB 1016 can control the stepper motor-driven conveyors 106 in a given row that move containers along the drink preparation apparatus 100. The master PCB 1002 can control the conveyor PCB 1016 via the CAN bus. The conveyor PCB 1016 can detect when a glass has passed a certain point before the ice dispensing stage using IR break beam sensors. The conveyor PCB 1016 can also control an LED strip and laser line indicators over the row to act as a visual indicator for glass drop offs and drink pickups. The conveyor PCB 1016 can include a microcontroller, which can include ATmega328P @ 16 MHz, ICSP programming header, serial header, reset button, and pins (MISO, MOSI, SCK, RST, TXD, and RXD). The conveyor PCB 1016 can include a power supply, which can include a 24V to 5V regulator and 2×5P 2.54 mm pin headers (+24V & GND). The conveyor PCB 1016 can include a CAN interface, which can include a MCP2515 Controller @ 16 MHz, TJA1050 transceiver, 2P 2.54 mm pin header, and pins (MISO, MOSI, SCK, PB2 (CAN_CS line), and PD2 (INTO)). The conveyor PCB 1016 can include a 16-bit port expander (MCP23S17) with pins (MISO, MOSI, SCK, Pxx (IO_CS), and 2×Pxx (INTA & INTB)). The conveyor PCB 1016 can include 3× stepper motor driver circuits, which can include a A4989 stepper driver, 2-5 A peak adjustable current limit, EN indicator LED, 2×4P 2.54 mm pin headers (to steppers), 3× up to 3.0 A stepper motors, and pins (OCOA, OCOB, OCIA (STEP), 3×Pxx (DIR), and 3×Pxx (EN)). The conveyor PCB 1016 can include IR break beam sensors, which can include indicator LED, 2P 2.54 mm pin header with IR break beam emitter, 3P 2.54 mm pin header with IR break beam receiver (open collector), and pins (INTn (Sensor Input), LED Strip, dual tristate buffers for MOSI & SCK (SN74LVC2G125), 2P 2.54 mm Pin Header (MOSI+SCK) with APA102/SK9822 LED strip (1 m, 144 LEDs), and pins (MOSI, SCK, Pxx (LED_CS). The conveyor PCB 1016 can include a row select circuit, which can include A vs. B indicator LEDs, 2P 2.54 mm shunt jumper (w/pull-up resistor), and Pxx pins. The conveyor PCB 1016 can include 4× laser indicator pairs, low-side MOSFET drive, 2×2P 2.54 mm Pin Header, and either no pins or a port expander.

The ice bin PCB 1018 can control the ice agitation in the ice reservoir 116 as well as monitor the ice levels in the ice reservoir 116. The ice bin PCB 1018 can include stepper motors drive an auger, linear rails, and a rotating ice agitator (e.g., ice auger 302). The ice bin PCB 1018 can monitor the ice level by using a waterproof ultrasonic distance sensor. The ice bin PCB 1018 can be autonomous or controlled by the master PCB 1002 via the CAN bus. The ice bin PCB 1018 can include a microcontroller, which can include an ATmega328P @ 16 MHz, an ICSP programming header, a serial header, a reset button, and pins (MISO, MOSI, SCK, RST, TXD, RXD). The ice bin PCB 1018 can include a power supply, which can include a 24V to 5V regulator, or a 2×5P 2.54 mm Pin Headers (+24V & GND). The ice bin PCB 1018 can include a CAN Interface, which can include a MCP2515 Controller @ 16 MHz, a TJA1050 transceiver, a 2P 2.54 mm pin header, and pins (MISO, MOSI, SCK, PB2 (CAN_CS line), PD2 (INTO)). The ice bin PCB 1018 can include 2×2.5 A stepper motor driver circuits and linear rails, which can include a DRV8825 stepper driver, a 2.5 A peak fixed current limit, a EN & FAULT indicator LEDs, 2×4P 2.54 mm pin headers to steppers with linear rails, and pins (OCIA (Shared STEP), 1×Pxx (Shared DIR), and 1×Pxx (Shared EN)). The ice bin PCB 1018 can include 2×5 A stepper motor driver circuits with an agitator and auger, which include a A4989 stepper driver, a 5 A peak fixed current limit, a EN indicator LED, a 2×4P 2.54 mm pin headers to stepper (auger 5.0 A with 6P 2.54 mm screw terminal and rotary encoder, and agitator 5.0 A), and pins (OCOA, OC2B (STEP), 2×Pxx (DIR), 2×Pxx (EN)). The ice bin PCB 1018 can include 2× limit switch circuits with a pull-up resistor, a debounce circuit, indicator LEDs, 2P 2.54 mm pin header, mechanical limit switches, and 2×PCx pin. The ice bin PCB 1018 can include ice level sensor circuits with 4P 2.54 mm Pin Header with a waterproof ultrasonic sensor, a 3P 2.54 mm pin header with sensor filtered/raw reading select, and pins (1×Pxx to Serial RX (e.g., software serial)).

The cooling PCB 1020 can include a house mix board that can control the cooling system that chills the house mixes in the drink preparation apparatus 100. The cooling PCB 1020 can use several TEC1-12730 thermoelectric coolers (TECs) to refrigerate the house mixes in conjunction with several fans for heat exhaust/air circulation and two BME280 temperature/humidity sensors. The cooling PCB 1020 can communicate with the master PCB 1002 via the CAN bus to provide temperature readings or adjust its cooling behavior. The cooling PCB 1020 can include a microcontroller, which can include an ATmega328P @ 16 MHz, ICSP programming header, serial header, reset button, and pins (MISO, MOSI, SCK, RST, TXD, and RXD). The cooling PCB 1020 can include a power supply, which can include a 12V to 5V Regulator and 2× Phoenix MSTBA 4 Connectors with 12V Power In & GND. The cooling PCB 1020 can include a CAN Interface, which can include a MCP2515 controller @ 16 MHz, TJA1050 transceiver, optional termination resistors (shunt jumpers), 2×JST PH 2 Connectors (CAN bus), and pins (MISO, MOSI, SCK, Pxx (CAN_CS line), and INTn). The cooling PCB 1020 can include 2× temperature sensor circuits, which can include a BME280 breakout module (using I2C), 4P 2.54 mm header, and pins (SDA, and SCL). The cooling PCB 1020 can include 4×15 A TEC driver circuits, which can include TEC1-12730 Peltier Module (up to 26 A drive current), LT3763 high current step-down LED driver controller, 2× adjustable potentiometers for setting output voltage and current, indicator LEDs for ENABLE and !FAULT lines, optional JST PH 2 connector (for external NTC thermistor to regulate output current based on temperature), Phoenix MSTBA 2 Connector, and pins 4×Pxx (EN). The cooling PCB 1020 can include 2× fan driver circuits (for cooling air circulation), which can include 140 mm case fans, low-side N-Channel MOSFET, indicator LED, 3 Molex KK 254 connector, and pins Pxx (enable or optionally PWM drive).

The master PCB 1002 can transmit a message to update activities or states of the drink preparation apparatus 100 when changes occur. The message can include “STATE_UPDATE.” The updates can relate to activities of the ice dispenser 114, the nozzle 118, or the pumps 124. The processor 602 can transmit a message to acknowledge receipt. The message can include “STATE_UPDATE_ACK.”

The processor 602 can transmit a message to request the master PCB 1002 to suspend its actions. The message can include “PAUSE.” This message enables the processor 602 to correct unexpected problems that may occur during testing and normal operation of the drink preparation apparatus 100. The master PCB 1002 can transmit a message to acknowledge receipt of the pause message and confirm suspension of operation. The message can include “PAUSE_ACK.” For example, the master PCB 1002 can suspend any or all of the components described herein. The processor 602 can transmit a message to request the master PCB 1002 to resume its actions after being paused. The message can include “UNPAUSE.” The master PCB 1002 can transmit a message to acknowledge receipt and confirm that it has resumed operation of any or all of the components described herein. The message can include “UNPAUSE_ACK.”

The processor 602 can transmit a message to request the master PCB 1002 to perform a software reset. The message can include “SOFT_RESET.” The master PCB 1002 can transmit a message to acknowledge receipt and confirm that it will reset. The message can include “SOFT_RESET_ACK.” For example, the master PCB 1002 can restart or clear temporary memory contents of any or all of the components described herein.

The processor 602 can transmit a message to instruct master PCB 1002 to shut down the drink preparation apparatus 100. The message can include “SHUTDOWN.” The master PCB 1002 can transmit a message to acknowledge receipt. The message can include “SHUTDOWN_ACK.” For example, the master PCB 1002 can shut down any or all of the components described herein.

The processor 602 can transmit a message to request that the master PCB 1002 stop its conveyor 106 and flash LEDs over a specified number of positions in preparation for addition or removal of containers on the conveyor 106. The message can include “FREEZE_INPUT.” The message can specify which color LEDs to flash. The master PCB 1002 can transmit a message to acknowledge receipt and indicate which positions are to be used and the color of their corresponding LEDs. The message can include “FREEZE_INPUT_ACK.” In some embodiments, the master PCB 1002 can also transmit a message to acknowledge receipt and indicate it was unable to allocate space on the conveyor 106 because there was insufficient space. The message can include “FREEZE_INPUT_NAK.”

The processor 602 can transmit a message to indicate to the master PCB 1002 that a container is at a specified position on the input 802 and provides the necessary information for the master PCB 1002 system to create the drink. The message can include “SEND_DRINK.” The message can include a container size (e.g., small, medium, large, or stemmed), a number of liquids in the recipe, a liquid number, and a liquid quantity (e.g., 0.05 oz. increments). The message can also indicate whether to dispense ice in the drink and how much ice its quantity indicates a number of scoops to dispense from the ice reservoir 116. The master PCB 1002 can transmit a message to confirm receipt. The message can include “SEND_DRINK_ACK.” Conversely, the master PCB 1002 can also transmit a message to acknowledge receipt and indicate that it was unable to accept the message due to an error. The message can include “SEND_DRINK_NAK.”

The master PCB 1002 can transmit a message to indicate that a container is misaligned under the ice dispenser 114. The message can include “ERROR_GLASS_POS.” The master PCB 1002 can transmit a message to indicate that it was unable to dispense ice because it detected that the ice reservoir 116 is empty. The message can include “ERROR ICE EMPTY.” The master PCB 1002 can transmit a message to indicate that it was unable to finish dispensing one or more liquids because it detected the specified liquid was used up while dispensing. The message can include “ERROR_INGR_EMPTY.” The message can specify which liquid (e.g., whiskey) was used up and in which receptacle (e.g., receptacle 120A) and drawer (e.g., drawer 112B). The processor 602 can transmit a message to acknowledge receipt and indicate that the master should wait for the processor 602 to provide additional instructions or messages. The message can include an “ERROR ACK.”

The processor 602 can transmit a message to indicate that the master PCB 1002 should reattempt whatever operation caused an error during dispensing (e.g., after a liquid is replaced or a glass is realigned). The message can include “RETRY.” The master PCB 1002 can transmit a message to acknowledge receipt. The message can include “RETRY_ACK.” The processor 602 can transmit a message to indicate that the master should substitute one liquid number with another and reattempt to dispense the drink. The message can include “SUB_AND_RETRY.” The message can include a number of substitutions to make, an old liquid number, and a new replacement liquid number. The master PCB 1002 can transmit a message to acknowledge receipt. The message can include “SUB_AND_RETRY_ACK.” The processor 602 can transmit a message to indicate removal of a container from the conveyor 106. The message can include “CANCEL_DRINK.” The message can also include a request for the master PCB 1002 to purge its data structures with information relating to the removed container. The master PCB 1002 can transmit a message to acknowledge receipt. The message can include “CANCEL_DRINK_ACK.”

The processor 602 can transmit a message to request that the master PCB 1002 restart the conveyors 106 and stop flashing any LEDs on or adjacent to the conveyors 106. The message can include “UNFREEZE_INPUT.” For example, the processor 602 can send the Unfreeze Input message after the drink is prepared. The master PCB 1002 can transmit a message to confirm receipt of the “UNFREEZE_INPUT” message and that it has successfully un-frozen the conveyors 106. The message can include “UNFREEZE_INPUT_ACK.”

The processor 602 can transmit a message to request that the master PCB 1002 stop its output conveyor (e.g., an independent different portion of the conveyor 106) and flash LEDs over specified pickup area on the output conveyors in preparation for containers to be picked up. The message can include “FREEZE_OUTPUT.” The message can specify that the flashes correspond to a number of drinks or positions. The master PCB 1002 can transmit a message to acknowledge receipt and provide the color of their corresponding LEDs over the positions containing the specified drink IDs. The message can include “FREEZE_OUTPUT_ACK.” The message can include specific colors of the LEDs. Conversely, the master PCB 1002 can transmit a message to acknowledge receipt and indicate that it was unable to find the specified drink IDs on the output conveyor. The message can include “FREEZE_OUTPUT_NAK.” The processor 602 can transmit a message to indicate to the master PCB 1002 that the specified drinks have been removed from output conveyors so the master PCB 1002 can clear them from its internal data structures. The message can include “PICK_UP_DRINK.” The message can include identifiers of the drinks. The master PCB 1002 can transmit a message to confirm receipt and picking up of the drink. The message can include “PICK_UP_DRINK_ACK.” Conversely, the master PCB 1002 can transmit to confirm receipt, but indicate that it was unable to complete the pickups due to an error. The message can include “PICK_UP_DRINK_NAK.” The processor 602 can transmit a message to request that the master PCB 1002 stop flashing the LEDs on the output conveyor and unfreeze the output conveyor. The message can include “UNFREEZE_OUTPUT.” The master PCB 1002 can transmit a message to confirm receipt and successful performance of the unfreezing of the conveyors. The message can include “UNFREEZE_OUTPUT_ACK.”

The processor 602 can transmit a message to request that the master PCB 1002 prepare for dispensing calibration by moving the nozzle 118 to a predetermined position above the conveyor 106 and illuminating the corresponding LEDs near of the conveyor 106. The message can include “CAL_PREP.” The master PCB 1002 can transmit a message to acknowledge receipt and confirm that the above actions have been performed. The message can include “CAL_PREP_ACK.” The processor 602 can transmit a message to request that the master PCB 1002 dispense a calibration amount of a specified liquid in order to calibrate the liquid dispensing system. The message can include “CAL_DISP.” The message can include a specific liquid to dispense. The master PCB 1002 can transmit a message to acknowledge receipt and confirm that the calibration liquid has finished dispensing. The message can include “CAL_DISP_ACK.” Conversely, the master PCB 1002 can transmit a message to acknowledge receipt and an indication that it was unable to dispense the calibration liquid due to an error. The message can include “CAL_DISP_NAK.” The error can relate to pumping of the liquid. The processor 602 can transmit a message to provide an exact measured volume of the calibration amount dispensed so the master PCB 1002 can calibrate its liquid dispensing for that liquid. The message can include “CAL_VAL.” The message can include a liquid number and a volume measured (e.g., in 0.05 oz. increments). The master PCB 1002 can transmit a message to acknowledge receipt of the “CAL_VAL” message and confirm calibration of the liquid dispensing for the liquid. The message can include “CAL_VAL_ACK.” Conversely, the master PCB 1002 can transmit a message to acknowledge receipt, but that it was unable to calibrate the liquid due to an error in the message, pump 124, or liquid. The message can include “CAL_VAL_NAK.” The master PCB 1002 can transmit a message to request the master PCB 1002 to start calibrating a liquid or its corresponding pump. The message can include “CAL_PRIME_START.” The message can include a liquid number to specify the liquid. The processor 602 can transmit a message to acknowledge receipt and to confirm starting the calibration process. The message can include “CAL_PRIME_START_ACK.” The master PCB 1002 can transmit a message responsive to the processor 602 requesting to increment the amount dispensed. The message can include “CAL_PRIME_INCR.” The message will appear until the liquid exits the nozzle 118. The master PCB 1002 can transmit a message responsive to the processor 602 indicating that the liquid has been primed and that calibration is complete. The message can include “CAL_PRIME_DONE.” Conversely, the master PCB 1002 can transmit a message requesting the master PCB 1002 to abort the calibration. The message can include “CAL ABORT.”

The processor 602 can transmit a message to request the master PCB 1002 to dump its log file. The message can include “LOG_REQ.” The master PCB 1002 can transmit a message with log dump header to notify the processor 602 of incoming log messages. The message can include “LOG_DUMP.” The master PCB 1002 can transmit a message with actions performed by the master PCB 1002. The message can include “LOG_MSG.” The actions can include dispensing events, conveyor 106 movements, or any other action of the master PCB 1002 or drink preparation apparatus 100 described herein. The master PCB 1002 can transmit a message to indicate that the transmission of the log files is complete. The message can include “LOG_END.” The processor 602 can transmit a message to acknowledge its receipt of the log file so that the master PCB 1002 can clear its local copy of the log file. The message can include “LOG_ACK.”

The master PCB 1002 can transmit a message to request a current epoch time from processor 602 to set a real-time clock “RTC” of the master PCB 1002. The message can include “CLOCK_SYNC_REQ.” The processor 602 can transmit a message to respond with a clock synchronization. The message can include “CLOCK_SYNC_REPLY.” The message can include the current UNIX epoch, expressed as a 32-bit integer representing seconds since 12:00 a.m. on Jan. 1, 1970.

The processor 602 can transmit a message to indicate a liquid swap procedure. The message can include “INGR_SWAP_START.” For example, the message can relate to changing liquids such as an un-prime house mix or a frozen machine. The message can specify the liquid number of the swapped liquid. The master PCB 1002 can transmit a message to indicate that the bar preparation apparatus 100 is ready to have the liquid swapped. The message can include “INGR_SWAP_START_ACK.” The processor 602 can transmit a message when the new liquid is swapped for the master PCB 1002 to jostle the pumps 124 and prepare liquids such as by re-priming house mix. The message can include “INGR_SWAP_DONE.” The master PCB 1002 can transmit a message to indicate that the new liquid is ready. The message can include “INGR_SWAP_DONE_ACK.” The processor 602 can transmit a message to request the master PCB 1002 to prime a liquid line prior to dispensing. The message can include “PRIME”. The message can specify the liquid or an associated connector 122 connected to the associated receptacle 120 having the liquid. The master PCB 1002 can transmit a message to inform the processor 602 that priming is complete. The message can include “PRIME_DONE.”

The master PCB 1002 can transmit a message to indicate temperature sensor readings from the house mix drawer (e.g., drawer 112A). The message can include “TEMP_UPDATE.” The message can include low and high temperatures for each drawer (e.g., drawer 112A and drawer 112B).

The processor 602 can transmit a message to request the master PCB 1002 to prepare to receive a file to store on the master's onboard storage. The message can include “TRANSFER_START.” The message can specify the file such as its name or format. For example, the file can be a firmware update and the storage can be a microSD card. The master PCB 1002 can transmit a message to acknowledge receipt and indicate that it is ready to receive the file contents over a connection such as a serial or USB bus. The message can include “TRANSFER READY.” The processor 602 can transmit a message to send the contents of the specified file. The message can include “TRANSFER_DATA.” The master PCB 1002 can transmit a message to acknowledge receipt and confirm that it successfully received and stored the file on its storage. The message can include “TRANSFER_ACK.” Conversely, the master PCB 1002 can transmit a message to acknowledge receipt and indicate that the transfer failed. The message can include “TRANSFER_NAK.” For example, the failure can occur responsive to storage issues, such as a corrupted SD card. The processor 602 can transmit a message to request the master PCB 1002 to program a specified target board with a specified binary file stored in the master's onboard storage. The message can include “PROGRAM_REQ.” For example, the message can specify a file and a target such as a pump 124, and the file can update the firmware of the pump 124. The master PCB 1002 can transmit a message to acknowledge receipt and confirm that it has successfully reprogrammed the target board. The message can include “PROGRAM_ACK.” Conversely, the master PCB 1002 can transmit to acknowledge receipt but indicate that the programming failed for a specified reason. The message can include “PROGRAM_NAK.” The message can include a reason, such as a verification error or a corrupted storage. The processor 602 can transmit a message to request the master PCB 1002 to reprogram itself using a binary file stored in the master's onboard storage. The message can include “SELF_PROGRAM_REQ.” The message can specify the file to use for reprogramming. The master PCB 1002 can transmit a message to acknowledge receipt and confirm that it successfully reprogrammed itself. The message can include “SELF_PROGRAM_ACK.” A bootloader of the master PCB 1002 can transmit the message is upon completion of self-programming. Conversely, the master PCB 1002 can transmit a message to acknowledge receipt and indicate that the programming failed. The message can include “SELF_PROGRAM_NAK.” For example, programming can fail if a file is missing.

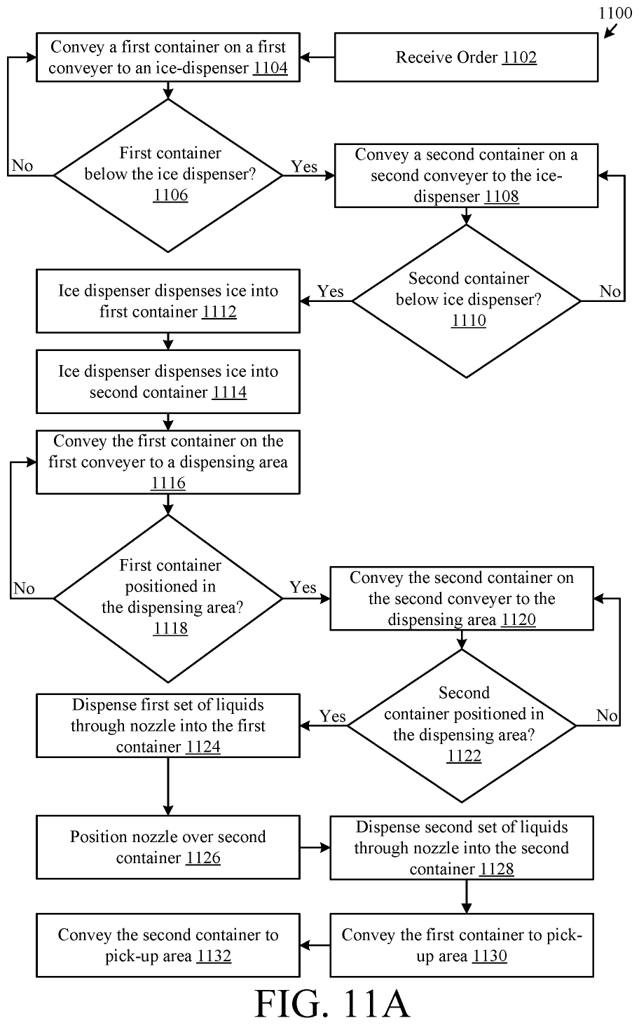

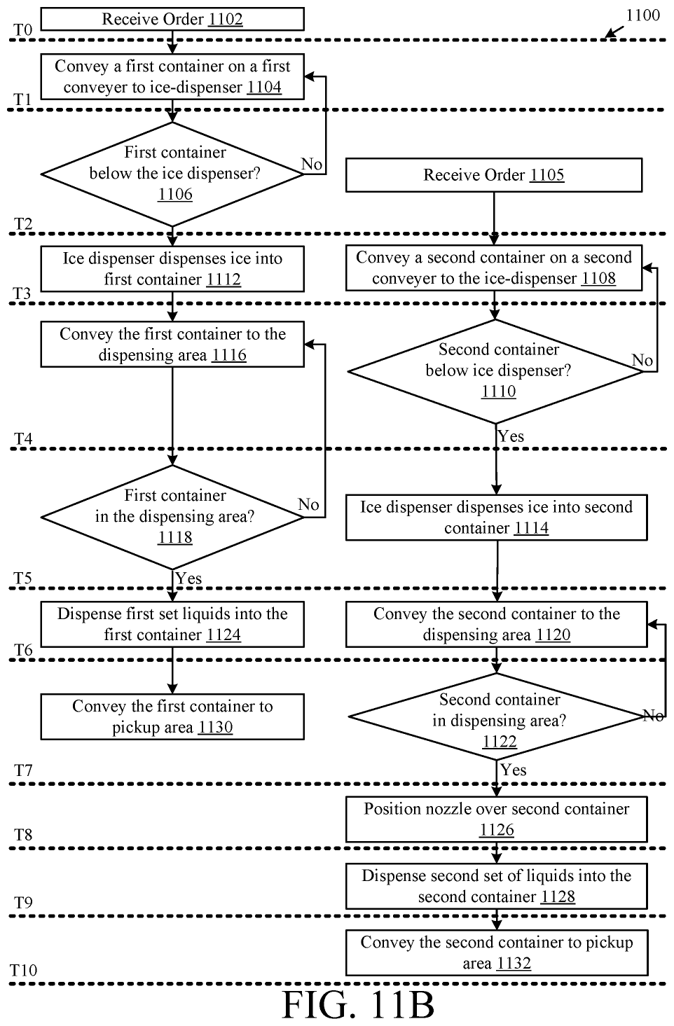

Referring now to FIG. 11A, shown is a flow diagram of an implementation of a method 1100 for preparing drinks. A processor (e.g., processor 602), or any other computing devices can execute, perform, or otherwise carry out the method 1100. Components described in FIGS. 1-10 and detailed above can perform the operations and functionalities of the method 1100. In brief overview, the processor can receive a drink order (STEP 1102). If the order includes a request for ice, the method 1100 can proceed to STEP 1104. Conversely, if the order does not include a request for ice, the method 1100 can proceed to STEP 1116. A first conveyor conveys a first container to an ice dispensing area (STEP 1104). If the first container is not below the ice dispenser (STEP 1106), the method returns to STEP 1104 to further change the physical location of the first container. When the processor determines that the container is below the ice dispenser (STEP 1106), the first conveyor stops and a second conveyor conveys a second container to the ice dispensing area (STEP 1108). If the second container is not below the ice dispenser (STEP 1110) the method returns to STEP 1108 to further change the physical location of the second container. When the processor determines that the second container is below the ice dispenser (STEP 1110), the second conveyor stops. The ice dispenser dispenses ice into the first container (STEP 1112) and into the second container (STEP 1114). If the order includes a request for liquids, the method 1100 can proceed to STEP 1116. Conversely, if the order only includes a request for ice, the method 1100 can proceed to STEP 1130. The first conveyor conveys the first container to a dispensing area (STEP 1116). If the first container is not in the dispensing area (STEP 1116), the method returns to STEP 1112 to further change the physical location of the first container. When the processor determines that the container is in the dispensing area (STEP 1118), the first conveyor stops. The second conveyor conveys the second container to the dispensing area (STEP 1120). If the second container is not in the dispensing area (STEP 1122), the method returns to STEP 1120 to further change the physical location of the second container. When the processor determines that the second container is in the dispensing area (STEP 1122), the second conveyor stops. The nozzle dispenses a first set of liquids into the first container (STEP 1124). The nozzle is moved into position over the second container (STEP 1126) and the nozzle dispenses a second set of liquids into the second container (STEP 1128). The first container is conveyed away from the nozzle to a pickup area (STEP 1130). The second container is conveyed from the nozzle to a pickup area (STEP 1132).

The processor can receive a drink order (STEP 1102). The drink order can be transmitted via a network (e.g., network 902). The drink order can request a first drink and/or a second drink with specific liquids. The process can verify the availability of a first set of liquid (e.g., in the receptacle 120A stored in the drawer 112B and/or the receptacle 120B stored in the drawer 112A) for the first drink.

The first conveyor (e.g., conveyor 106A) conveys the first container to a first ice dispenser (e.g., ice dispenser 114A) (STEP 1104). The first conveyor can convey the first container disposed on the first conveyor to a dispensing area (e.g., dispensing area 110). A motor can drive the first conveyor to convey the first container. The processor can transmit instructions to control the motor.

The processor can determine if the first container on the first conveyor is below the ice dispenser (STEP 1104). The processor can use sensors to determine whether the first container is below the ice dispenser. The conveyor below the ice dispenser can include sensors indicating when the container is below the ice dispenser. The ice dispenser or dispensing area (e.g., dispensing area 110) can also include sensors to identify or sense when the container is in the dispensing area. If the processor determines that the first container is not below the ice dispenser, then the method 1100 returns to STEP 1104 to further change the physical location of the first container. Conversely, if the processor determines that the first container is below the ice dispenser, then the method 1100 continues to STEP 1108.

The second conveyor (e.g., conveyor 106B) can convey the second container to a second ice dispenser (e.g., ice dispenser 114B) (STEP 1108). The second conveyor can convey the second container disposed on the second conveyor to the dispensing area below the ice dispenser. A motor can drive or rotate the second conveyor to move or transport the second container. The processor can transmit instructions to control the motor. The second conveyor can convey the second container independently of the actions of the other components described herein. For example, the second conveyor can convey the second container while the pumps pump liquids through the nozzle for release into the first container positioned in the dispensing area.

The processor can determine if the second container on the second conveyor is below the ice dispenser (STEP 1110). The processor can use sensors to determine whether the second container is below the ice dispenser. The drink preparation apparatus can include sensors indicating when the container is below the ice dispenser. The ice dispenser or dispensing area can also include sensors to identify or sense when the container is below the ice dispenser. If the processor determines that the second container is not below the ice dispenser, then the method 1100 returns to STEP 1108 to further change the physical location of the second container. Conversely, if the processor determines that the first container is below the ice dispenser, then the method 1100 continues to STEP 1112.

The ice dispenser dispenses ice into the first container (STEP 1112) and into the second container (STEP 1114). The processor can determine a number of ice units requested by the first drink. The processor can instruct the ice auger (e.g., ice auger 302) to move ice into the ice dispenser. The ice dispenser has chambers that dispense a set volume of ice. The processor can instruct the ice dispenser to turn a certain number of times to dispense the correct multiple of that volume for each glass type. Similarly, the processor can determine a volume of ice requested by the second drink. The processor can instruct the ice auger (e.g., ice auger 302) to move ice into the ice dispenser. The processor can instruct the ice dispenser to dispense the determined number of volume.

The first conveyor can convey the first container on the first conveyor to a dispensing area (e.g., beneath a nozzle 118) (STEP 1116). The processor can determine or verify if the first container is in the dispensing area (STEP 1118). The processor can use lasers to indicate a first position of the first container on the first conveyor. The drink preparation apparatus can include sensors indicating when the first container is below the nozzle. The nozzle or the dispensing area can also include sensors to identify or sense when the first container is below the nozzle. If the processor determines that the first container is not below the nozzle, then the method 1100 returns to STEP 1116 to further change the physical location of the first container. Conversely, if the processor determines that the first container is below the nozzle, then the method 1100 continues to STEP 1120.

The second conveyor can convey the second container on the second conveyor to the nozzle (STEP 1120). The processor can actuate the stepper motor (e.g., motor to drive the conveyor 106) to convey the first container to the nozzle. The processor can determine or verify if the second container is in the dispensing area (STEP 1122). The processor can use lasers to indicate a second position of the second container on the second conveyor. The drink preparation apparatus can include sensors indicating when the second container is below the nozzle. The nozzle or the dispensing area can also include sensors to identify or sense when the second container is below the nozzle. If the processor determines that the second container is not below the nozzle, then the method 1100 returns to STEP 1120 to further change the physical location of the second container. Conversely, if the processor determines that the second container is below the nozzle, then the method 1100 continues to STEP 1124.

The nozzle can dispense the first set of liquids through the nozzle into the first container (STEP 1124). In some embodiments, the processor can control a gantry (e.g., gantry 402) to move the nozzle to a first dispensing position (e.g., dispensing position 404A). The nozzle is moved along the gantry into position over the second container (STEP 1126). The processor can control the gantry (e.g., gantry 402) to move the nozzle to a second dispensing position (e.g., dispensing position 404B). The processor can request the pumps to pump the first set of liquids through the nozzle for release into the first container below the nozzle. The nozzle dispenses a second set of liquids into the second container (STEP 1128). The processor can request the pumps to pump a second set of liquids through the nozzle for release into the second container.

The first conveyor can convey the first container to a pickup area (STEP 1130). The pickup area can be a zone for patrons or employees to pick up the container with their drink order. The processor can actuate the stepper motor (e.g., driving the conveyor 106) to convey the first container away from the nozzle. The first conveyor can then receive another container and prepare another drink. The second conveyor can convey the second container to the pickup area (STEP 1132). The processor can actuate the motor to convey the second container away from the nozzle. The second conveyor can then receive another container and prepare another drink. The processor can transmit a notification to a machine tablet (e.g., screen 108) that the first drink and the second drink are ready.

Although described above as a series of steps happening seriatim, some of the described steps of may happen in parallel. Now referring to FIG. 11B, shown is an embodiment of the method 1100 with time components T0-T10. Each time component can represent a duration of time, such as 1 second, 5 seconds, 30 seconds, or 1 minute. Each time component can represent a different duration of time, such as for example T0 can represent 1 second and T1 can represent 5 seconds. At T0, the processor can receive an order (STEP 1101). Although similar to the order received in STEP 1102, the order may only include a request for a first drink. At T1, the conveyor thus conveys the first container to the ice dispenser to prepare the first drink (STEP 1104). However, at T2, the drink preparation apparatus can also receive an order with a request for a second drink (STEP 1105) while determining whether the first container is below the ice dispenser (STEP 1106). By receiving the orders at different times, the drink preparation apparatus can prepare the drinks in parallel. Therefore, T3 can include both the ice dispenser dispensing ice into the first container (STEP 1112) and the second conveyor conveying the second container to prepare the second drink (STEP 1108). T4 can include determining whether the first container is in the dispensing area (STEP 1118) while the second container is filled with ice (STEP 1114). At T5, the nozzle dispenses the first of set of liquids into the first container in the dispensing area (STEP 1124) while the second container is just being conveyed to the dispensing area (STEP 1120). At T6, the first container includes the first drink so it is conveyed to the pickup area (STEP 1130) while determining whether the second container is in the dispensing area (STEP 1122). At T8-T10, the first conveyor of the drink preparation apparatus is idle and can thus convey additional containers for preparing additional drinks. Meanwhile, the nozzle is positioned over the second container to dispense liquids for the second drink (STEP 1126), the liquids are dispensed (STEP 1128), and the second container with the second drink is conveyed to the pickup area (STEP 1132).

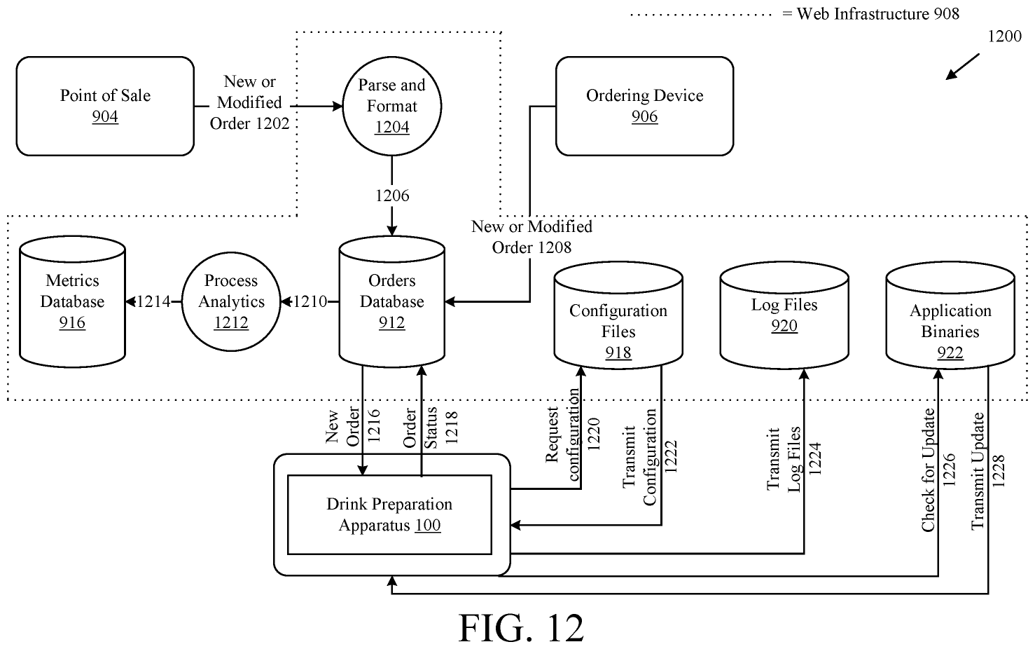

Referring now to FIG. 12, shown is a flow diagram of an embodiment of a flow 1200 for ordering drinks. A processor (e.g., processor 602), or any other computing devices can execute, perform, or otherwise carry out the flow 1200. Components described in FIGS. 1-10 and detailed above can perform the operations and functionalities of the flow 1200. In brief overview, the POS system 904 can submit a new or modified order for a drink (1202). The web infrastructure 908 can parse and format the order (1204). The web infrastructure 908 can submit the parsed and formatted order to the orders database 912 (1206). The ordering device 906 can also submit a new or modified order for a drink (1208). The orders database 912 can store the orders from the POS system 904 or the ordering device 906). The web infrastructure 908 can submit the stored order for processing (1210). The web infrastructure 908 can process analytics relating to the order (1212). The web infrastructure 908 can submit the analytics to the metrics database 916 for storage as metrics (1214). The web infrastructure 908 can submit the new or modified order to the drink preparation apparatus 100 (1216). The drink preparation apparatus 100 can transmit an order status (1218). The drink preparation apparatus 100 can request the configuration files 918 from the web infrastructure 908 (1220). The web infrastructure 908 can transmit the configuration to the drink preparation apparatus 100 (1222). The drink preparation apparatus 100 can send log files 920 for storage in the web infrastructure 908 (1224). The drink preparation apparatus 100 can query the web infrastructure for updates to the application binaries 922 (1226). The web infrastructure 908 can send the application binaries 922 to the drink preparation apparatus 100 (1228).

Still referring to FIG. 12 and in further detail, the POS system 904 can submit a new or modified order for a drink (1202). For example, a waiter at a restaurant can submit the new or modified order for the drink. The POS system 904 can include details to make the drinks in the order, such as the amount, liquids, ice, and quantity of drinks. The web infrastructure 908 can parse and format the order (1204). The web infrastructure 908 can use the order parser 910 to parse or format the order. For example, the web infrastructure 908 can retrieve the details from the order to make the drinks in the order. The order parser 910 can also convert the order request from the POS system 904 into a format compatible with the apparatus 100. For example, the order parser 910 can convert the order into machine-readable instructions for the apparatus 100. The web infrastructure 908 can submit the parsed and formatted order to the orders database 912 (1206). The web infrastructure 908 can store the order in a format such that the apparatus 100 can prepare the drinks in the order. For example, the web infrastructure 908 can store the order as a text file or any other machine-readable instructions that the apparatus 100 can use to prepare the drinks in the order.

The ordering device 906 can also submit a new or modified order for a drink (1208). For example, a patron can submit the order via their personal device, such as a smartphone or tablet. A waiter or employee can also submit the order via their waiter tablet. The order can include details to make the drinks in the order, such as the amount, liquids, ice, and quantity of drinks. The orders database 912 can store the orders from the POS system 904 or the ordering device 906).

The web infrastructure 908 can submit the stored order for processing (1210). For example, the web infrastructure 908 can transmit instructions to prepare the order to the apparatus 100. The instructions can include the machine-readable instructions generated from the orders received via the POS system 904 or the ordering device 906. The web infrastructure 908 can process analytics relating to the order (1212). The web infrastructure can identify or determine analytics relating to the order. The analytics can include when the order was placed, who placed the order (e.g., based on user's device or waiter's device), where the order was placed (e.g., particular location in the restaurant), and the contents of the order (e.g., drink types and quantities). The web infrastructure perform statistical analysis on the analytics to compute or extract insights, patterns, or associations relating to drink orders. The insights can include when orders are placed (e.g., evening), which drinks are popular at various times or establishments (e.g., alcoholic drinks more popular in the events), or which devices are associated with which drinks (e.g., identify particular waiter device associated with receiving a high or low amount of orders). The web infrastructure 908 can submit the analytics to the metrics database 916 for storage as metrics (1214). The web infrastructure 908 can store the analytics in the metrics database 916. The analytics can be anonymized to protect customer data (e.g., remove customer's personal information from drink orders). Administrators of the web infrastructure 908 or the establishment (e.g., restaurant manager or owner) can access the analytics for managing the apparatus and/or the establishment. For example, the administrators can use the analytics to identify which drinks are commonly ordered at each apparatus 100.

The web infrastructure 908 can submit the new or modified order to the drink preparation apparatus 100 (1216). The web infrastructure 908 can submit the orders by transmitting them to the apparatus 100 via a network (e.g., network 902). The web infrastructure 908 can transmit the drinks via an API. The transmission can include details for fulfilling the order, such as a number of drinks or drink type. For example, the order can include 6 drinks to be made by the apparatus 100. The drink preparation apparatus 100 can transmit an order status (1218). The order status can include whether the order is in preparation, prepared, or unable to be prepared. The apparatus 100 can determine that the order is in preparation by receiving data from the embedded controllers indicating that the conveyors are conveying containers for drinks in the order and/or that the nozzle is dispensing liquids into the containers to prepare the drinks. The apparatus 100 can determine that the order is prepared when the liquids for each drink in the order are dispensed and the containers with the drinks are conveyed to the pickup area by the conveyors. The apparatus can also determine that the order cannot be prepared if there is an error relating to the apparatus or the order. Apparatus errors can include a broken pump, nozzle, or conveyor. Order errors can include drinks that cannot be made (e.g., not allowed by the establishment such as because of regulations) or because some of the liquids are missing (e.g., apparatus 100 is out of vodka for a drink containing vodka). For example, the apparatus 100 can determine that the order cannot be made if it includes too many drinks (e.g., more than 6 drinks).

The drink preparation apparatus 100 can request the configuration files 918 from the web infrastructure 908 (1220). The configuration files can include configurations, settings, or information for the drink preparation apparatus 100. For example, the configuration files 918 can include permissions for handling drink orders received on the drink preparation apparatus 100 (e.g., via the screen 108). Examples of permissions include that the drink preparation apparatus 100 can use certain liquids (e.g., beer but not whiskey), that the drink preparation apparatus 100 can only dispense 50 mL of 40% liquor per drink order, or that the drink preparation apparatus 100 cannot accept more than three alcoholic drinks in one order. An administrator can load the configuration files 918 for transmission to the drink preparation apparatus 100. The apparatus 100 can transmit the request for configuration files via the network and/or an API. The web infrastructure 908 can transmit the configuration to the drink preparation apparatus 100 (1222). The configuration can include the configuration files from the database of the web infrastructure 908. The web infrastructure 908 can transmit the configuration via the network and/or an API.

The drink preparation apparatus 100 can send log files 920 for storage in the web infrastructure 908 (1224). The log files include information relating to the drink preparation apparatus 100. The drink preparation apparatus 100 can transmit the information for storage as the log files 920. The information can include time stamps relating to drink dispensing, quantity and type of drink dispensing, inventory levels of liquids, error messages, service logs, or status of the inline filter (e.g., inline filter 814). The apparatus 100 can transmit the log files via the network and/or an API.

The drink preparation apparatus 100 can query the web infrastructure for updates to the application binaries 922 (1226). The drink preparation apparatus 100 can transmit a request to check for updates to the firmware or software of the apparatus 100. The request can include information of the firmware, software, or hardware currently on the apparatus 100. The apparatus 100 can transmit the query via the network and/or an API. The web infrastructure 908 can send the application binaries 922 to the drink preparation apparatus 100 (1228). The application binaries can include software, firmware, or configurations relating to the drink preparation apparatus 100. The application binaries 922 can transmit software for the GUI presented on the display (e.g., display 108). The application binaries 922 can include drivers for interfacing with the sensors of the drink preparation apparatus 100. An administrator can load the application binaries 922 for transmission to the drink preparation apparatus 100.

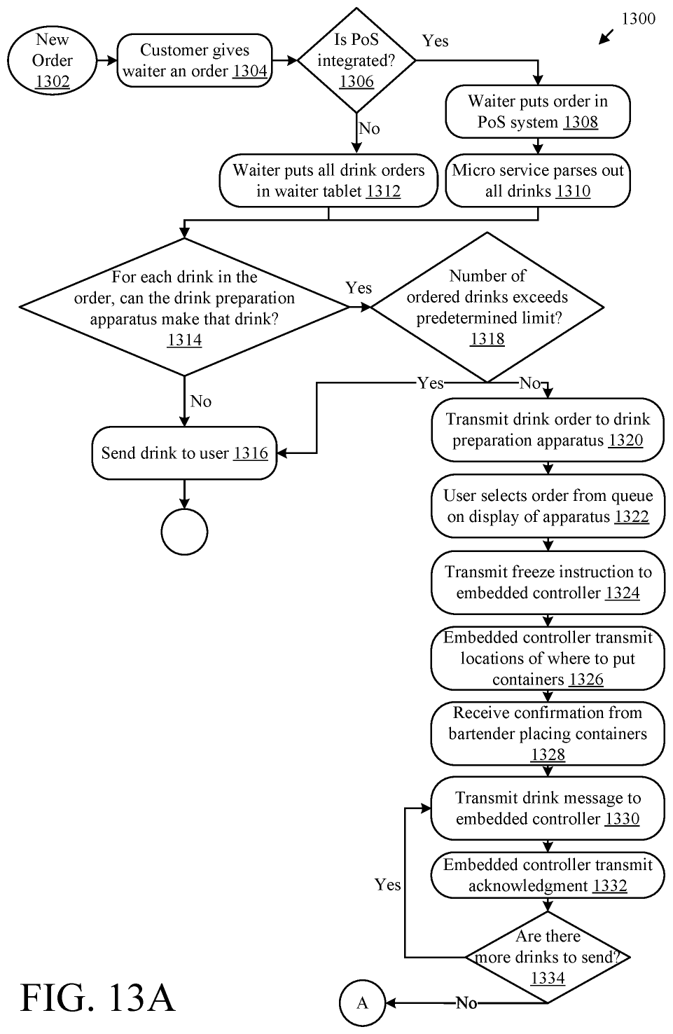

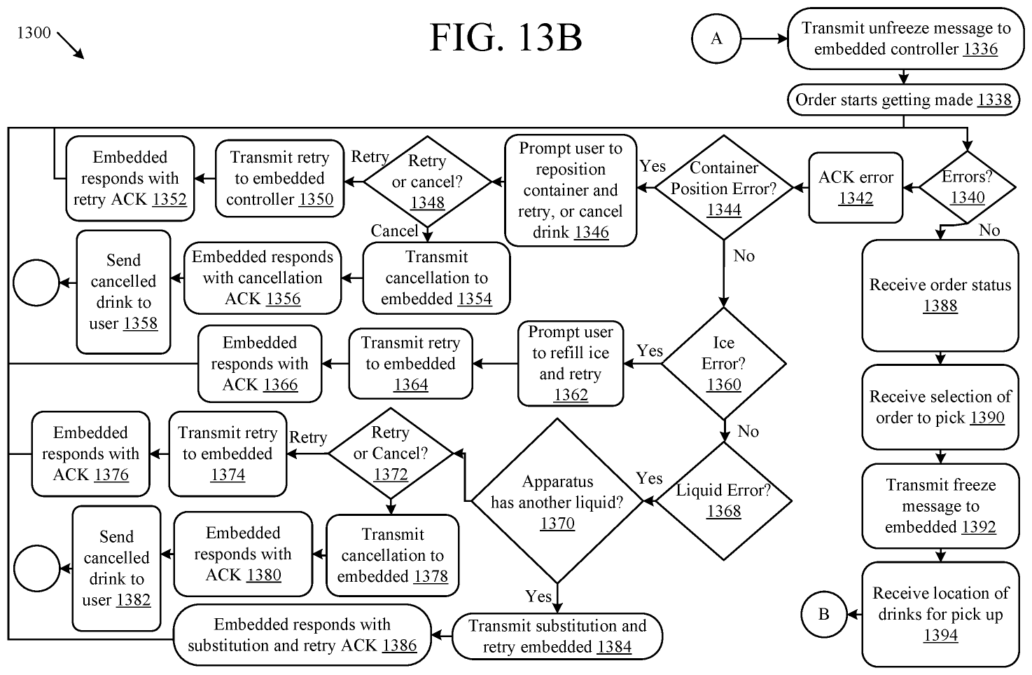

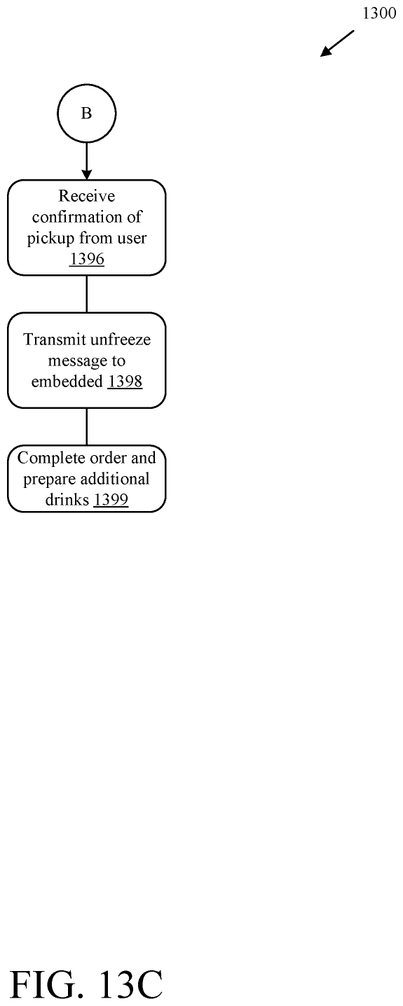

Referring now to FIGS. 13A-13C and in brief overview, shown are flow diagrams of an embodiment of a method 1300. A processor (e.g., processor 602), or any other computing devices can execute, perform, or otherwise carry out the method 1300. Components described in FIGS. 1-10 and detailed above can perform the operations and functionalities of the method 1300. In brief overview, the method 1300 can include generating or receiving a new order (STEP 1302). A customer can give a waiter an order with the requested drink (STEP 1304). The waiter can determine whether the point-of-sale system of the establishment is integrated with the apparatus 100 (STEP 1306). If the POS system is integrated, then the waiter can put the order into the point-of-sale system (STEP 1308). A micro service of the POS system can then parse the submission to identify the requested drinks in the order (STEP 1310). If the point-of-sale system is not integrated, then the waiter can put the order into a waiter tablet (STEP 1312). The POS system and/or the waiter tablet can determine if the drink preparation apparatus 100 can prepare each drink in the order (STEP 1314). If the apparatus 100 cannot make the drinks in the order, then the order is sent to the user (STEP 1316). If the apparatus 100 can make the drink, then the POS system and/or the waiter tablet can determine if the number of drinks in the order exceeds a predetermined limit (STEP 1318). If the order includes more than the predetermined limit, then the order is sent to the user (STEP 1316). If the number of drinks does not exceed the predetermined limit, the drinks order is sent to the apparatus 100 (STEP 1320). The user can select the order from a queue on the apparatus (STEP 1322). The processor can transmit a freeze message to an embedded controller (STEP 1324). The processor can receive a response from the embedded controller with locations of where to put the containers (STEP 1326). The user can place the containers on the conveyor and confirms that they have been placed (STEP 1328). The processor can transmit a drink message to the embedded controller (STEP 1330). The processor can receive an acknowledgement message from the embedded controller responsive to receiving the order (STEP 1332). The processor can determine if there are additional drink orders to send (STEP 1334). If there are additional drink orders, then the processor proceeds to STEP 1328. If there are no additional drink orders to send, then the method 1300 proceeds to STEP 1336.

The processor can send an unfreeze message the embedded controller (STEP 1336). The drink preparation apparatus 100 can begin to prepare the order (STEP 1338). The processor can determine if there are errors in drink preparation (STEP 1340). If there is an error, then embedded controller can transmit the error to the processor and the method 1300 proceeds to STEP 1342. The processor can acknowledge the error (STEP 1342). The processor can determine if there is a container position error (STEP 1344). If there is a container position error, the user can be prompted to reposition the container and retry or cancel the drink order (STEP 1346). The processor can receive a selection of whether to retry or cancel the order (STEP 1348). If the user decides to retry the order, then the processor can transmit a message to the embedded controller (STEP 1350). The embedded controller can transmit an acknowledgement message and proceed to STEP 1340 (STEP 1352). If the user decides to cancel the order, then the processor can transmit a cancellation message to the processor (STEP 1354). The embedded controller can transmit an acknowledgement message to acknowledge the cancellation of the drink order (STEP 1356). The processor can transmit the canceled drink to the user so that the user can attempt to make the drink manually (STEP 1358).

If there is no container position error, then the processor can determine if there is an ice error (STEP 1360). If there is an ice error, then the processor can prompt a user to refill the ice reservoir and retry the drink order (STEP 1362). The processor can transmit a retry message to the embedded controller (STEP 1364). The embedded controller can transmit an acknowledgment message and proceed to STEP 1340 (STEP 1366).

If there is no ice error, then the processor can determine if there is a liquids error (STEP 1368). If there is a liquid error, then the processor can determine if the drink preparation apparatus 100 has another receptacle or refill of the missing liquid (STEP 1370). If the processor determines that the drink preparation apparatus 100 does not have a refill or analog of the missing liquid, the processor can receive an indication of whether to retry or cancel the order (STEP 1372). If the user decides to retry the order, then the processor can transmit a retry message to the embedded controller (STEP 1374). The embedded controller can transmit a message and proceed to STEP 1340 (STEP 1376). If the user decides to cancel the order, then the processor can transmit a cancellation message to the embedded controller (STEP 1378). The embedded controller can transmit an acknowledgment message to acknowledge the cancellation of the drink order (STEP 1380). The processor can send the canceled drink to the user so that the user can attempt to make the drink manually (STEP 1382). If the processor determines that there is a substitute liquid is available, the processor can transmit a retry message the embedded controller (STEP 1384). The embedded controller can transmit an acknowledgment message to the processor and begin to make the order with the substituted liquid (STEP 1386).

If there are no errors in drink preparation, then the processor can identify when the order is ready based on a status update message (STEP 1388). The processor can receive a selection from a user to select the order for pickup (STEP 1390). The processor can send a freeze message to the embedded controller (STEP 1392). The processor can display information and location of the prepared drinks for pick up (STEP 1394). The processor can receive an indication from the user when the order is picked up (1396). The processor can send an unfreeze message to the embedded controller (STEP 1398). The processor can determine that the order is complete and can process additional drink orders (STEP 1399).

Referring now to FIG. 13A and in further detail, the method 1300 can include generating or receiving a new order (STEP 1302). For example, a customer at an establishment can request a drink. A customer can give a waiter an order with the requested drink (STEP 1304). The customer can provide the order via a customer device, or submit a request via waiter device. The order can include drinks, beverages, and other liquids. The order can include specifics for the order, such as quantity of drinks, and specifics for the drinks, such as drink names, ingredients, or amounts of each liquid. The waiter can determine whether the point-of-sale system (e.g., POS system 904) of the establishment (e.g., restaurant or bar) is integrated with the apparatus 100 (STEP 1306). The waiter can attempt to use the POS system to submit the order to the apparatus 100. For example, an integrated POS system can communicate with the apparatus via a pre-configured application programming interface (API). If the POS system is integrated, then the waiter can put the order into the point-of-sale system (STEP 1308). The waiter can submit the order along with any related information (e.g., type of drink, ingredients, quantity, etc.) on a user input device or interface of the point-of-sale system.

A micro service of the POS system can parse the submission to identify the requested drinks in the order (STEP 1310). The micro service can identify the details relating to the order. If the point-of-sale system is not integrated, then the waiter can put the order into a waiter tablet (e.g., ordering device 906) (STEP 1312). The waiter can submit the type of drink and any related information (e.g., ingredients, quantity, etc.) that the customer requested on a user input device or interface of the point-of-sale system.

The POS system and/or the waiter tablet can determine if the drink preparation apparatus 100 can prepare each drink in the order (STEP 1314). The POS system and/or the waiter tablet can analyze the ordered drinks to determine if the apparatus 100 can make them (e.g., a restaurant or bar can decide which drinks are to be made by the bartender (or any user such as a staff member) and which drinks are to be made by the apparatus 100, such as for entertainment or marketing reasons). If the apparatus 100 cannot make the drinks in the order, then the order is sent to the user (STEP 1316). In some embodiments, the POS system and/or the waiter tablet split the order such that a drinks in the order than can be made by the apparatus 100 are sent to the apparatus 100, while the drinks that the apparatus 100 cannot make are sent to the user. The drinks and recipes that are sent to the user can be printed for preparation by the user.

If the apparatus 100 can make the drink, then the POS system and/or the waiter tablet can determine if the number of drinks in the order exceeds a predetermined limit (STEP 1318). The POS system and/or the waiter tablet can identify a number of drinks in the order, and compare the number to a predetermined limit set by the POS system and/or the waiter tablet. For example, the POS system and/or waiter tablet can set the predetermined limit to six drinks. The apparatus 100 can receive the predetermined limit from the POS system and/or waiter tablet. If the order includes more than the predetermined limit, then the order is sent to the user (STEP 1316). For example, the order may be from a large group or group such and the establishment may prefer to have its staff serve large groups and/or verify large orders. If the number of drinks does not exceed the predetermined limit, the drinks order is sent to the apparatus 100 (STEP 1320). For example, the POS system and/or waiter tablet can packetize the order and transmit it to the apparatus 100 via a network (e.g., network 902).

The user can select the order from a queue on the apparatus (e.g., display 108) (STEP 1322). The processor of the apparatus 100 can receive the order and display it for the user. The user can select to prepare the order via a graphical user interface of the apparatus 100. The processor can transmit a freeze message to an embedded controller (e.g., master PCB 1002) (STEP 1324). The message can include a “FREEZE_INPUT” instruction. For example, after the user selects the order, the processor can instruct the apparatus 100 (e.g., instruct master PCB 1002) to stop the conveyors and flash LEDs over a specified number of positions to indicate where containers are to be added or removed. The processor can receive a response from the embedded controller with locations of where to put the containers (STEP 1326). The locations can be instructions and/or reference numbers to locations on the conveyor. The locations can include a particular conveyor to place the containers. For example, the locations can indicate that the container can be placed on a first conveyor. The location can also indicate where on the conveyor to place the container. For example, the locations can indicate to put the container two feet to the left of the dispensing area. The user can place the containers on the conveyor and confirms that they have been placed (STEP 1328). For example, the user can confirm that the placement of the containers by via a touchscreen display 108.

The processor can transmit a drink message to the embedded controller (STEP 1330). The request can include a “SEND_DRINK” command. The message can indicate that the containers are positioned on the conveyor and provide the necessary information to create the drink. The message can include a container size (e.g., small, medium, large, or stemmed), a number of liquids in the recipe, a liquid number, and a liquid quantity (e.g., 0.05 oz. increments). Ice can also be a liquid and its quantity indicates a number of scoops to dispense from the ice reservoir (e.g., ice reservoir 116). The processor can receive an acknowledgement message from the embedded controller responsive to receiving the order (STEP 1332). The message can include an “ACK” command. The message can indicate that the embedded controller received the message to make the drink. In some embodiments, the “ACK” message indicates that the embedded controller was unable to accept the message. For example, message can be corrupted or the apparatus cannot make the drink (e.g., apparatus broken or liquids unavailable). The processor can determine if there are additional drink orders to send (STEP 1334). If there are additional drink orders, then the processor proceeds to STEP 1328. For example, the drink order can have several drinks, and each one should be sent to the apparatus 100. If there are no additional drink orders to send, then the method 1300 proceeds to STEP 1336. For example, the method 1300 proceeds to 1336 if there are no additional drinks in the order to be sent to the embedded controller.

Referring now to FIG. 13B and in further detail, the processor can send an unfreeze message the embedded controller (STEP 1336). The message can include an “UNFREEZE_INPUT” instruction. The message can request that the embedded controller restart the conveyors and stop flashing any LEDs on or adjacent to the conveyors. The drink preparation apparatus 100 can begin to prepare the order (STEP 1338). The embedded controller can instruct the conveyors to convey the drinks to the dispensing area. The processor can determine if there are errors in drink preparation (STEP 1340). The embedded controller can receive messages from sensors or other components relating to the preparation of the drink. If there is an error, then embedded controller can transmit the error to the processor and the method 1300 proceeds to STEP 1342. The processor can acknowledge the error (STEP 1342). The processor can transmit an acknowledgement to the component that transmitted the error. For example, the processor can acknowledge an error message from the conveyors. The processor can determine if there is a container position error (STEP 1344). For example, the processor can receive a message indicating that a container is misaligned under the ice dispenser. If there is a container position error, the user can be prompted to reposition the container and retry or cancel the drink order (STEP 1346). The processor can display an indication that the container is not properly positioned. The processor can receive a selection of whether to retry or cancel the order (STEP 1348). The processor can display a prompt via a user interface to request the user selection. If the user decides to retry the order, then the processor can transmit a message to the embedded controller (STEP 1350). The message can include a “RETRY” instruction. The user can reposition the container and select to retry the order. The embedded controller can transmit an acknowledgement message and proceed to STEP 1340 (STEP 1352). The message can include a “RETRY_ACK” instruction. The message can indicate that the embedded controller will attempt to prepare the drink again, such as by conveying the repositioned conveyor to the dispensing area. If the user decides to cancel the order, then the processor can transmit a cancellation message to the processor (STEP 1354). The message can include a “CANCEL_DRINK” instruction. For example, the user may want to make the drink manually without the apparatus. The cancellation message can include a request to delete the drink from the order queue. The cancellation message can also request that the cancellation is transmitted to another device, such as another apparatus 100 that can make the drink, or logged. The embedded controller can transmit an acknowledgement message to acknowledge the cancellation of the drink order (STEP 1356). The message can include a “CANCEL_DRINK_ACK” instruction. The message can indicate that the embedded controller cancelled the drink order. The embedded controller can begin preparing another order and/or transmit the cancelled order to another device. The processor can transmit the canceled drink to the user so that the user can attempt to make the drink manually (STEP 1358). The apparatus can notify the user of any canceled drinks from the order and includes their recipes such that the user can manually prepare the drink for the customer.

If there is no container position error, then the processor can determine if there is an ice error (STEP 1360). The processor can receive a message from the embedded controller that indicates that the ice reservoir does not have ice to dispense. The message can include a reason for why there is no ice, such as a clogged water line, a non-responsive ice auger, or that the apparatus has not finished preparing ice. The processor can display the error and the reason for the user. If there is an ice error, then the processor can prompt a user to refill the ice reservoir and retry the drink order (STEP 1362). For example, the processor can prompt the user to open the ice reservoir to manually add ice. The processor can transmit a retry message to the embedded controller (STEP 1364). The message can include a “RETRY” instruction. For example, the user can select an option in the prompt to indicate that they added ice to the ice reservoir so the apparatus 100 should retry to prepare the drink. The embedded controller can transmit an acknowledgment message and proceed to STEP 1340 (STEP 1366). The message can include a “RETRY_ACK” instruction. The embedded controller can attempt to prepare the drink again.

If there is no ice error, then the processor can determine if there is a liquids error (STEP 1368). The liquid error can indicate that the apparatus 100 cannot dispense a particular liquid for the drink. Reasons for the liquid error include not having the liquid, a broken pump, or a clogged nozzle. If there is a liquid error, then the processor can determine if the drink preparation apparatus 100 has another receptacle or refill of the missing liquid (STEP 1370). For example, the processor can interface with the sensors in the drawers to determine which liquids are available. The processor can also identify and suggest available liquids as replacements (e.g., suggest a different brand of whiskey if the ordered whiskey is unavailable). If the processor determines that the drink preparation apparatus 100 does not have a refill or analog of the missing liquid, the processor can receive an indication of whether to retry or cancel the order (STEP 1372). For example, the processor can display a prompt that requests the user whether to retry the order without the liquid or to cancel the order. If the user decides to retry the order, then the processor can transmit a retry message to the embedded controller (STEP 1374). The message can include a “RETRY” instruction. The message can include information relating to any modifications to the drink order, such as the removal of the unavailable liquid. The embedded controller can transmit a message and proceed to STEP 1340 (STEP 1376). The message can include a “RETRY_ACK” instruction. The embedded controller can attempt to prepare the drink without the unavailable liquid. If the user decides to cancel the order, then the processor can transmit a cancellation message to the embedded controller (STEP 1378). The message can include a “CANCEL_DRINK” instruction. For example, the user can select to cancel the order via the graphical user interface, and the processor can transmit the message instructing the embedded controller to delete the order from its queue and/or memory. The embedded controller can transmit an acknowledgment message to acknowledge the cancellation of the drink order (STEP 1380). The message can include a “CANCEL_DRINK_ACK” instruction. The embedded controller can also delete the drink order from its local memory and/or send a log of the cancelled drink order to another apparatus or the web infrastructure. The embedded controller can then proceed to make other drinks in the drink order that are not cancelled. The processor can send the canceled drink to the user so that the user can attempt to make the drink manually (STEP 1382). For example, the apparatus notifies the user of any canceled drinks from the order and includes their recipes such that the user can manually prepare the drink for the customer. If the processor determines that there is a substitute liquid is available, the processor can transmit a retry message the embedded controller (STEP 1384). The message can include a “SUB_AND_RETRY” instruction. For example, the processor can determine that the missing liquid can be substituted with another liquid. The processor can display a prompt that suggests the user to retry the order with a different liquid (e.g., substitute orange juice for apple juice). In some embodiments, the user can add the missing liquid to the apparatus (e.g., add a bottle of the missing liquid to the drawer). The user can select the newly added liquid or a substitute liquid to use in the drink order. The message from the processor to the embedded controller can include information relating to any modifications to the drink order, such as the removal or substitution of the unavailable liquid. The embedded controller can transmit an acknowledgment message to the processor and begin to make the order with the substituted liquid (STEP 1386). The message can include a “SUB_AND_RETRY_ACK” instruction. For example, the embedded controller can attempt to prepare the drink with the substitute or with the newly added refill liquid.

If there are no errors in drink preparation, then the processor can identify when the order is ready based on a status update message (STEP 1388). The message can include a “STATUS_UPDATE” instruction. For example, the embedded controller can determine based on the activity of the pumps and conveyors that the drink is prepared. In particular, after conveying the container, dispensing ice, pumping the liquids, and conveying the container to the pickup area, the embedded controller can determine that the drink is ready. The embedded controller can then generate and transmit the status update message to the processor to indicate that the drink is ready in the pickup area. The processor can receive a selection from a user to select the order for pickup (STEP 1390). The processor can display an interface with the multiple orders and multiple drinks being prepared. The prepared drinks may all be located in the pickup area. The processor can receive a selection from the user of the drink to pick up from the pickup area. The processor can send a freeze message to the embedded controller (STEP 1392). The message can include a “FREEZE_OUTPUT” instruction. The message can request the embedded controller to stop the conveyors such that user can pick up the prepared drink. The processor can display information and location of the prepared drinks for pick up (STEP 1394). The processor can request the embedded controller to indicate a location of the drink on the conveyor. The embedded controller can also use LEDs to indicate a location of the selected drink, such as by flashing the LEDs on the conveyor near the drink.

Referring now to FIG. 13C and in further detail, the processor can receive an indication from the user when the order is picked up (1396). The processor can display an interface with a prompt that allows for a selection to confirm that the drink was picked up. The processor can also receive an indication from the embedded controller that the drink was picked up. The embedded controller can determine that the drink was picked up by receiving measurements from motion sensors or weight sensors in the pickup area to identify that the drink was picked up. The processor can send an unfreeze message to the embedded controller (STEP 1398). The message can include an “UNFREEZE_OUTPUT” instruction. If the user indicates that the drink is off the conveyor, then the processor can send the message to request the embedded controller to restart the conveyor. The processor can determine that the order is complete and can process additional drink orders (STEP 1399). After receiving the selections and confirmations via the user interface that the drink was picked up, or after receiving a confirmation from the embedded controller that the drink was picked up, the processor can submit additional requests for the embedded controller to prepare drinks. However, the processor can also receive additional drink orders at any time and store them in an order queue. For example, if the embedded controller can prepare one drink every 10 seconds, then processor can add receive an order with 5 drinks and then submit each drink sequentially to the embedded controller.

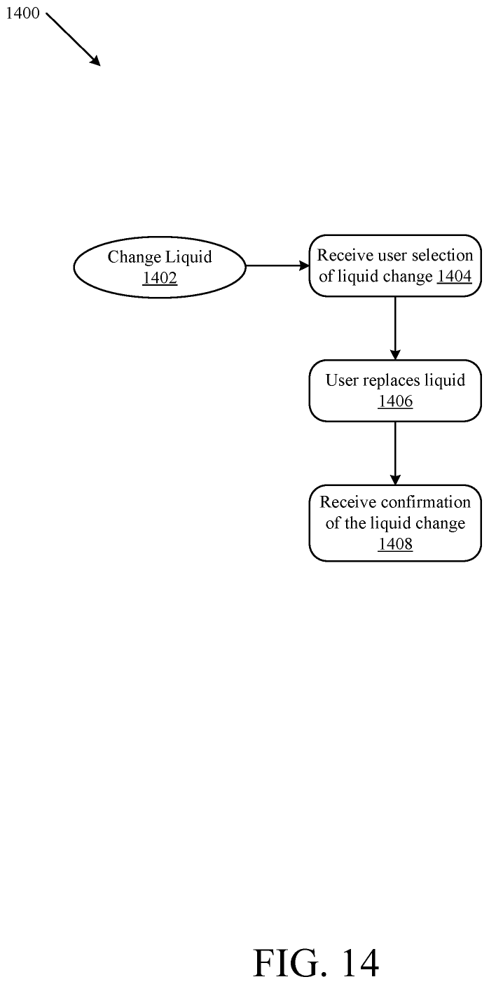

Now referring to FIG. 14 and in brief overview, shown is a flow diagram of an embodiment of a method for changing liquids. A processor (e.g., processor 602), or any other computing devices can execute, perform, or otherwise carry out the method 1400. Components described in FIGS. 1-10 and detailed above can perform the operations and functionalities of the method 1400. In brief overview, the user can determine to change the receptacle in the ingredient cabinet (1402). The processor can receive a selection of a liquid to replace (1404). The user can replace the liquid in the ingredient cabinet and connect the new liquid to the pumps (1406). The processor can receive a confirmation of the liquid change (1408).

Still referring to FIG. 14 and in further detail, the user can determine to change the receptacle (e.g., receptacle 120) in the ingredient cabinet (e.g., ingredient cabinet 104) (1402). For example, the user can receive a prompt in the user interface on the display that a receptacle is empty or that a liquid is unavailable. The user can receive the prompt at scheduled intervals (e.g., expiration date of a liquid or within an empty threshold such as less than 20% remaining) or during preparation of the drink (e.g., the liquid emptied or leaked). The prompt can be responsive to a liquids error message as described herein. The user can also submit settings for the prompts, such as expiration dates for the liquids or thresholds at which to alert of low liquid (e.g., 10% remaining, 20% remaining, etc.). The user can also submit settings for automating reordering of liquids as they are used up. The ordering can be based on metrics relating to usage of the liquids (e.g., metrics database 916). The processor can receive a selection of a liquid to replace (1404). For example, the processor can suggest, via the user interface, a liquid to replace (e.g., empty receptacle or expired liquid) or a display all the liquids stored in the drawer. The user can select to replace the suggested liquid and/or any of the liquids stored in the drawer. The processor can display a drawer and a connector (e.g., connector 122) where the user can find and replace the selected liquid.

The user can replace the liquid in the ingredient cabinet and connect the new liquid to the pumps (e.g., pumps 124) (1406). The user can open the drawers and install or refill a receptacle with liquid. The user can couple the receptacle to the connector such that a corresponding pump can pump the liquid. The processor can receive a confirmation of the liquid change (1408). The processor can receive user inputs confirming the liquid change and information relating to which liquid was replaced, changed, or refilled. The processor can receive measurements of the new liquid from the sensors in the drawers. For example, the measurements can indicate that the changed receptacle is full of liquid.

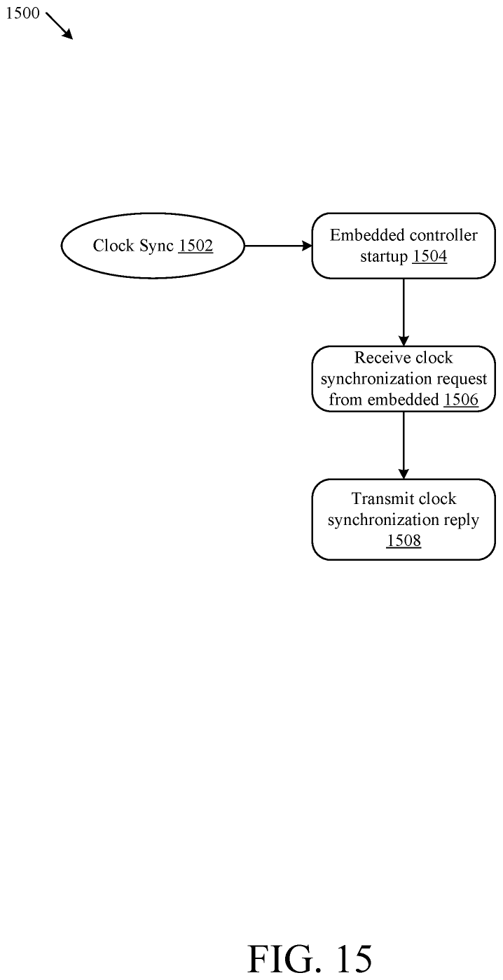

Now referring to FIG. 15 and in brief overview, shown is a flow diagram of an embodiment of a method for clock synchronization. A processor (e.g., processor 602), or any other computing devices can execute, perform, or otherwise carry out the method 1500. Components described in FIGS. 1-10 and detailed above can perform the operations and functionalities of the method 1500. In brief overview, the processor and the embedded controller can synchronize clocks (1502). The synchronization can occur during startup of the embedded controller (1504). The embedded controller can send a clock synchronization request message to the processor (1506). The processor can transmit a clock synchronization reply to confirm the synchronization of the clock (1508).

Still referring to FIG. 15 and in further detail, the processor and the embedded controller (e.g., master PCB 1002) can synchronize clocks (1502). Synchronizing the clocks of the computational elements of the processor and the embedded controller can prevent communication errors during the exchange of messages and data. The synchronization can occur during startup of the embedded controller (1504). For example, the embedded controller turns on when the apparatus 100 is powered on.

The embedded controller can send a clock synchronization request message to the processor (1506). The message can include a “CLOCK_SYNC_REQ” instruction. The message can request the processor to synchronize its computational clock with the computational clock of the embedded controller. The processor can transmit a clock synchronization reply to confirm the synchronization of the clock (1508). The message can include a “CLOCK_SYNC_REPLY” instruction. The message can include data for synchronizing the computational clock of the embedded controller, such as the current coordinated universal time.

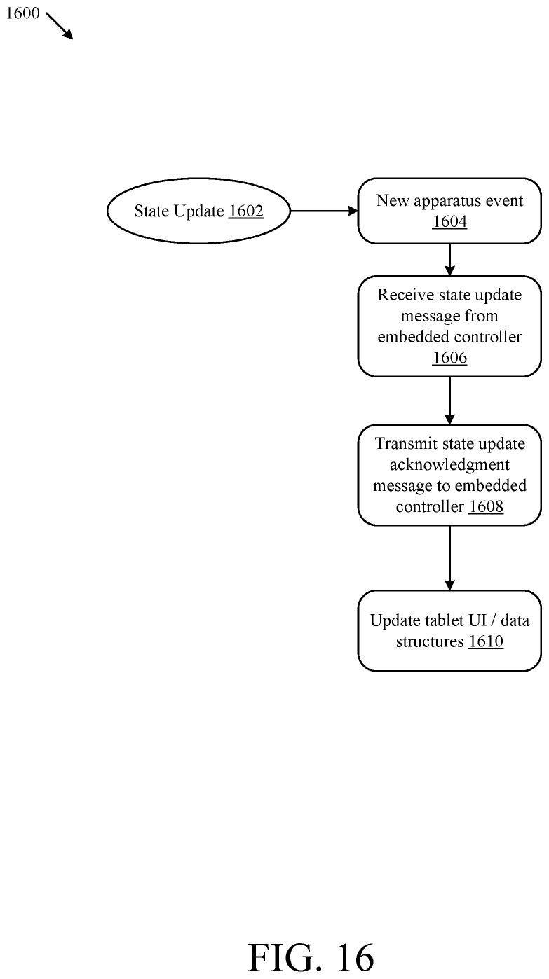

Now referring to FIG. 16 and in brief overview, shown is a flow diagram of an embodiment of a method for receiving state updates of the apparatus. A processor (e.g., processor 602), or any other computing devices can execute, perform, or otherwise carry out the method 1600. Components described in FIGS. 1-10 and detailed above can perform the operations and functionalities of the method 1600. In brief overview, the processor can receive state updates relating to the drink preparation apparatus 100 or the master PCB 1002 (1602). An event can occur in the machine (1604). The embedded controller can transmit a status update message to the processor to indicate the new event (1606). The processor can transmit an acknowledgement of the update to the embedded controller (1608).

Still referring to FIG. 16 and in further detail, the processor can receive state updates relating to the drink preparation apparatus 100 or the master PCB 1002 (1602). The status updates can relate to activities of the ice dispenser, the nozzle, or the pumps. For example, the status updates can indicate that the pumps are pumping, that the nozzle is moving along the gantry, or that the ice dispenser is dispensing ice. An event can occur in the machine (e.g., conveyor moved or drink dispensed) (1604). For example, the event can indicate that the conveyor moved the container as part of preparing a drink order.

The embedded controller (e.g., master PCB 1002) can transmit a status update message to the processor to indicate the new event (1606). The message can include a “STATUS_UPDATE” instruction. The message can include information about any event of any of the components of apparatus 100. For example, the message can indicate that a conveyor is moving a container having a particular weight to fulfill a specific drink order. The processor can transmit an acknowledgement of the update to the embedded controller (1608). The transmission can include a “STATUS_UPDATE_ACK” instruction. The message can indicate that the processor received the information from the embedded controller. The processor can update the user interface or data structures relating to the event. For example, the processor can display the status updates in the user interface, or the processor can store the status updates as a log file. The processor can then transmit the state updates to a web infrastructure (e.g., log files 920) for storage and analysis.

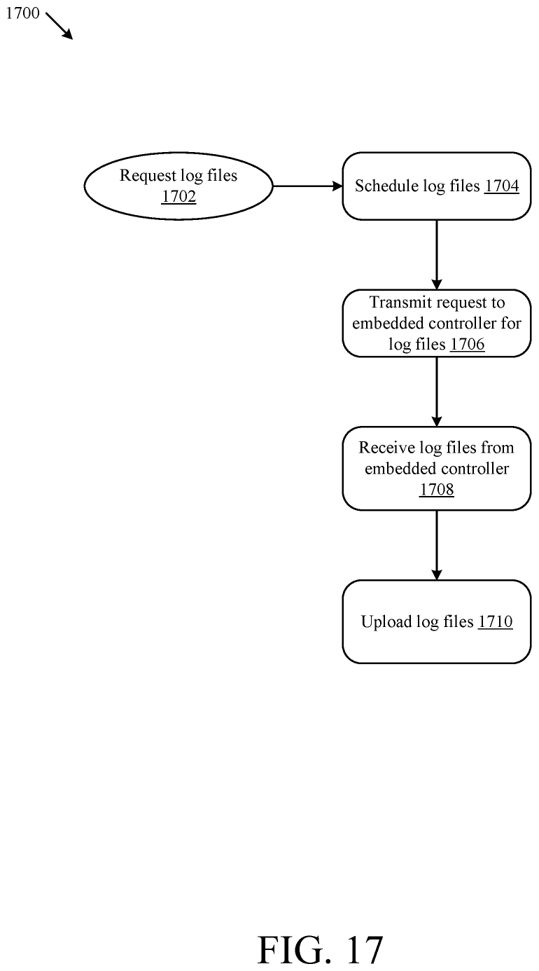

Now referring to FIG. 17 and in brief overview, shown is a flow diagram of an embodiment of a method for generating a log dump. A processor (e.g., processor 602), or any other computing devices can execute, perform, or otherwise carry out the method 1700. Components described in FIGS. 1-10 and detailed above can perform the operations and functionalities of the method 1700. In brief overview, the processor can manage or request log dumps (STEP 1702). The processor can schedule the log dumps (STEP 1704). The processor can transmit a request to the embedded controller for log files (STEP 1706). The processor can receive the log files from the embedded controller (STEP 1708). The processor can upload the log files to a web infrastructure (STEP 1710).

Still referring to FIG. 17 and in further detail, the processor can manage or request log dumps (e.g., log files 920) (STEP 1702). The log dump can include information about events or actions involving the components of the apparatus 100. The information can be from the status update or state update messages. For example, the information can indicate that a conveyor is moving a container having a particular weight to fulfill a specific drink order. The processor can schedule the log dumps (STEP 1704). The processor can schedule the log dumps at various intervals such as daily, weekly, or monthly. The processor can schedule the log dumps according to user settings received via the display. The processor can transmit a request to the embedded controller for log files (e.g., master PCB 1002) (STEP 1706). The request can include a “LOG_REQ” instruction. The processor can send the message at the scheduled times or responsive to a request, such as from a service technician. The message can request logs for a particular time range (e.g., last 30 days) or for a particular component (e.g., actions of the conveyor).

The processor can receive the log files from the embedded controller (STEP 1708). The message can include a “LOG_DUMP” instruction. The message can include log files with the requested information. For example, if the processor requested logs for the conveyor, then the log files can include information about the conveyor. The processor can upload the log files to a web infrastructure (e.g., web infrastructure 908) (STEP 1710). The processor can upload the log files at scheduled intervals (e.g., corresponding to the scheduled log dumps) or responsive to a request, such as from a central administrator that manages the web infrastructure for the apparatus.

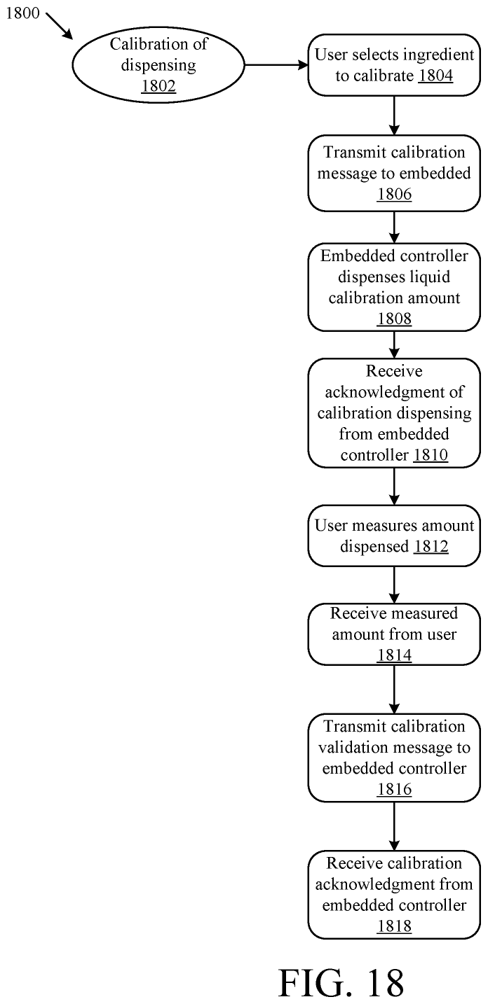

Now referring to FIG. 18 and in brief overview, shown is a flow diagram of an embodiment of a method calibrating the drink preparation apparatus. A processor (e.g., processor 602), or any other computing devices can execute, perform, or otherwise carry out the method 1800. Components described in FIGS. 1-10 and detailed above can perform the operations and functionalities of the method 1800. In brief overview, the apparatus can calibrate the dispensing of liquids (STEP 1802). The processor can receive a selection of pumps to calibrate (STEP 1804). The processor can send a calibration message to the embedded controller to request dispensing of a liquid for calibration (STEP 1806). The embedded controller can cause the drink preparation apparatus 100 to dispense the liquid (STEP 1808). The embedded controller can send an acknowledgement message to the processor to acknowledge dispensing of the liquid (STEP 1810). The user can measure the amount of the liquid dispensed (STEP 1812). The processor can receive the measurement from the user (STEP 1814). The processor can send a calibration validation message to the embedded controller (STEP 1816). The processor can receive an acknowledgement message from the embedded controller (STEP 1818).

Still referring to FIG. 18 and in further detail, the apparatus can calibrate the dispensing of liquids (e.g., pumps 124 dispensing liquids from receptacles 120) (STEP 1802). The apparatus calibrates the dispensing to accurately and precisely dispense liquids. The apparatus can dispense a test liquid for a user to measure and provide to the apparatus. The apparatus can then compare the expected amount dispensed to the measured amount dispensed to adjust the dispensing of the liquids. The apparatus can calibrate the dispensing responsive to a request. For example, a technician can request calibration via a user interface on the display. The apparatus can also calibrated the dispensing at scheduled intervals or events (e.g., installation of new pumps). The processor can receive a selection of pumps to calibrate (STEP 1804). The processor can receive the selection via the user interface on the display. For example, the processor can receive a selection of a pump that pumps syrup. The processor can send a calibration message to the embedded controller (e.g., master PCB 1002) to request dispensing of a liquid for calibration (STEP 1806). The message include a “CAL_DISP” instruction. The message can specify the pump selected for calibration, and amount of liquid (e.g., 5 mL, 10 mL, 25 mL, 100 mL, etc.) to dispense.

The embedded controller can cause the drink preparation apparatus 100 to dispense the liquid (STEP 1808). The embedded controller can actuate the selected pump to dispense the amount of liquid specified the calibration message. The embedded controller can send an acknowledgement message to the processor to acknowledge dispensing of the liquid (STEP 1810). The message can include a “CAL_DIP_ACK” instruction. The message can indicate which pump dispensed the specified amount of liquid.

The user can measure the amount of the liquid dispensed (STEP 1812). The user can use any measurement technique such as a flask or beaker to measure the amount of liquid dispensed. The processor can receive the measurement from the user (STEP 1814). The processor can receive the measurement from the user via the user interface on the display. The measurement can be received as a numeric amount of measured liquid (e.g., 24 mL). The processor can compare the received measurement to the calibration amount.

The processor can send a calibration validation message to the embedded controller (STEP 1816). The message can include a “CAL_VAL” instruction. The message can indicate if the measurement corresponds to a predetermined calibration amount. Conversely, the message can indicate that the measurement does not correspond to the calibration amount, and request the embedded controller to adjust the dispensing of the pump. For example, if the pump dispensed too much liquid, then the message can request embedded controller to reduce how much liquid the pump dispenses, such as by reducing an on time or power provided to the pump. Conversely, if the pump didn't dispense enough liquid, then the message can request that the embedded controller keep the pump on longer or increase power provided to the pump. The processor can receive an acknowledgement message from the embedded controller (STEP 1818). The message can include a “CAL_VAL_ACK” instruction. The message can indicate that the embedded controller received the calibration adjustment message and adjusted the pump settings if necessary.

While various embodiments of the methods and systems have been described, these embodiments are illustrative and in no way limit the scope of the described methods or systems. Those having skill in the relevant art can effect changes to form and details of the described methods and systems without departing from the broadest scope of the described method and systems. Thus, the scope of the methods and systems described herein should not be limited by any of the illustrative embodiments and should be defined in accordance with the accompanying claims and their equivalents.

What is claimed is:

1. A drink preparation apparatus comprising:
a nozzle defining a first pipe having a first diameter and a second pipe having a second diameter larger than the first diameter;
a gantry coupled to the nozzle, the gantry positioning the nozzle between a first nozzle position and a second nozzle position;
a first tube in fluidic communication with the first pipe and a second tube in fluidic communication with the second pipe;
a first peristaltic pump in fluidic communication with the first tube and a second peristaltic pump in fluidic communication with the second tube; and
a processor in electrical communication with the gantry, the first peristaltic pump, and the second peristaltic pump, the processor configured to:
transmit a first instruction to the gantry to position the nozzle in the first nozzle position or the second nozzle position;
transmit a second instruction to the first peristaltic pump to cause fluid to flow through the first tube to be dispensed from the first pipe; and
transmit a third instruction to the second peristaltic pump to cause fluid to flow through the second tube to be dispensed from the second pipe.

2. The drink preparation apparatus of claim 1, further including a first conveyor to position a first container under the first nozzle position and a second conveyor to position a second container under the second nozzle position.

3. The drink preparation apparatus of claim 2, the first conveyor including a proximal portion, a distal portion, and a middle portion under the first nozzle position and between the proximal portion and the distal portion.

4. The drink preparation apparatus of claim 3, further including an ice reservoir with ice and an ice augur providing the ice to an ice dispensing mechanism.

5. The drink preparation apparatus of claim 4, wherein the processor is further configured to transmit a fourth instruction to the ice dispensing mechanism to dispense the ice.

6. The drink preparation apparatus of claim 4, the ice dispensing mechanism further comprising:
an ice measurement chamber; and
a motor that rotates the ice measurement chamber to dispense the ice.

7. The drink preparation apparatus of claim 1, further comprising a cold plate coupled to the first tube and the second tube, the cold plate configured to cool fluids flowing through the first tube and the second tube.

8. The drink preparation apparatus of claim 1, further including a display screen, the display screen providing a graphical user interface for the drink preparation apparatus.

9. The drink preparation apparatus of claim 8, wherein the graphical user interface displays drinks to be dispensed from fluids in the first pipe and the second pipe.

10. The drink preparation apparatus of claim 9, wherein the display screen is a touch display receiving user selections of the drinks, and wherein the processor is further configured to transmit instructions to dispense the drinks.

11. The drink preparation apparatus of claim 1, further including a network interface receiving commands to operate the drink preparation apparatus.

12. The drink preparation apparatus of claim 1, further including an integration module configured to operate the drink preparation apparatus according to orders from a point-of-sale system.

13. A method of automatically preparing drinks, comprising:
conveying a first container disposed on a first conveyor to a fluid-dispensing area beneath a nozzle;
conveying a second container disposed on a second conveyor to the fluid-dispensing area;
pumping a first set of fluids through the nozzle into the first container;
positioning the nozzle over the second container;
pumping a second set of fluids through the nozzle into the second container; and
conveying the first container and the second container to a pickup area.

14. The method of claim 13, further comprising receiving a drink order transmitted via a network, the drink order identifying a first drink and a second drink.

15. The method of claim 14, further comprising identifying a first volume of a first fluid and a second volume of a second fluid for the first drink.

16. The method of claim 14, further comprising:
identifying an amount of ice for the first drink; and
dispensing ice via an ice measurement chamber into the first container until the amount of the ice has been dispensed.

17. The method of claim 14, further comprising transmitting a notification that the first drink and the second drink are ready.

18. The method of claim 13, further comprising indicating, using lasers, a first position for the first container on the first conveyor and a second position for the second container on the second conveyor.

19. The method of claim 13, further comprising verifying the first container was placed at a first position on the first conveyor and the second container was placed at a second position on the second conveyor.

20. A method of automatically preparing drinks, comprising:
transmitting, by the one or more processors, a first instruction to a first conveyor motor to convey a first container disposed on a first conveyor to a fluid-dispensing area beneath a nozzle;
transmitting, by the one or more processors, a second instruction to a second conveyor motor to convey a second container disposed on a second conveyor to the fluid-dispensing area;
transmitting, by the one or more processors, a third instruction to a first peristaltic pump to pump a first set of fluids through the nozzle into the first container;
transmitting, by the one or more processors, a fourth instruction to a gantry to position the nozzle over the second container;
transmitting, by the one or more processors, a fifth instruction to a second peristaltic pump to pump a second set of fluids through the nozzle into the second container; and
transmitting, by the one or more processors, an sixth instruction to the first conveyor and the second conveyor to convey the first container and the second container to a pickup area.
